(19) United States
(12) Patent Application Publication
(10) Pub. No.: US 2026/0075574 A1
(43) Pub. Date: Mar. 12, 2026

(54) METHOD AND APPARATUS FOR RANGING OR SL POSITIONING, AND STORAGE MEDIUM

(71) Applicant: VIVO MOBILE COMMUNICATION CO., LTD., Dongguan (CN)

(72) Inventors: Wen WANG, Dongguan (CN); Zhenhua XIE, Dongguan (CN); Hui JIN, Dongguan (CN)

(21) Appl. No.: 19/393,604

(22) Filed: Nov. 19, 2025

Related U.S. Application Data
(63) Continuation of application No. PCT/CN2024/092767, filed on May 13, 2024.

(30) Foreign Application Priority Data
May 19, 2023 (CN) 202310573746.0

(51) Int. Cl. H04W 64/00; H04W 92/18

(52) U.S. Cl. CPC H04W 64/00; H04W 92/18

(57) ABSTRACT

Provided are a ranging or SL positioning method and apparatus, and a storage medium. The ranging or SL positioning method includes following operations. A first terminal obtains first information. The first terminal performs a ranging-related or SL positioning-related operation based on the first information, where the first information is used to indicate at least one of the following: whether a serving network of the first terminal supports a ranging or SL positioning function; whether a second terminal supports the ranging or SL positioning function; and whether a serving network of the second terminal supports the ranging or SL positioning function, where the second terminal is a reference terminal discovered by the first terminal to perform the ranging-related or SL positioning-related operation.

### CROSS-REFERENCE TO RELATED APPLICATIONS

This application is a continuation of International Patent Application No. PCT/CN2024/092767, filed on May 13, 2024, which claims priority to Chinese Patent Application No. 202310573746.0, filed with the China National Intellectual Property Administration on May 19, 2023 and entitled "RANGING OR SL POSITIONING METHOD AND APPARATUS, AND STORAGE MEDIUM", both of which are incorporated herein by reference in their entireties.

### TECHNICAL FIELD

This application pertains to the field of communications technologies, and specifically relates to a ranging or SL positioning method and apparatus, and a storage medium.

### BACKGROUND

In scenarios of sidelink (sidelink, SL) positioning (Positioning) and/or ranging (Ranging), a target (Target) user equipment (User Equipment, UE) and a reference (Reference) UE (also referred to as an anchor (Anchor) UE) may not have a function of serving as an SL positioning server (Server) UE, for example, may not have a related function of the SL positioning server UE, such as providing a determining method for SL positioning or ranging, distribution of assistance data, or positioning calculation.

### SUMMARY

Embodiments of this application provide a ranging or SL positioning method and apparatus, and a storage medium.

According to a first aspect, a ranging or sidelink SL positioning method is provided, and is performed by a first terminal. The method includes: The first terminal obtains first information.

The first terminal performs a ranging-related or SL positioning-related operation based on the first information, where the first information is used to indicate at least one of the following: whether a serving network of the first terminal supports a ranging or SL positioning function; whether a second terminal supports the ranging or SL positioning function; and whether a serving network of the second terminal supports the ranging or SL positioning function, where the second terminal is a reference terminal discovered by the first terminal to perform the ranging-related or SL positioning-related operation.

According to a second aspect, a ranging or sidelink SL positioning method is provided, and is performed by a second terminal. The method includes:

The second terminal sends first information to a first terminal, where the first information is used to perform a ranging-related or SL positioning-related operation; or the second terminal receives first information from a first terminal; and the second terminal performs a ranging-related or SL positioning-related operation based on the first information, where the first information is used to indicate at least one of the following: whether a serving network of the first terminal supports a ranging or SL positioning function; whether the second terminal supports the ranging or SL positioning function; and whether a serving network of the second terminal supports the ranging or SL positioning function, where the second terminal is a reference terminal discovered by the first terminal to perform the ranging-related or SL positioning-related operation.

According to a third aspect, a ranging or sidelink SL positioning method is provided, and is performed by a network side device. The method includes: The network side device sends first information to a first terminal, where the first information is used to perform a ranging-related or SL positioning-related operation; or the network side device sends second information to a second terminal, where the second information is used to generate first information, the first information is used to perform a ranging-related or SL positioning-related operation, and the second information is used to indicate at least one of the following: whether the second terminal supports a function corresponding to a sidelink positioning server user equipment SL positioning server UE; whether a serving network of the second terminal supports a ranging or SL positioning function; whether the second terminal is within a service area; and whether the second terminal is within a restricted area; and the first information is used to indicate at least one of the following: whether a serving network of the first terminal supports the ranging or SL positioning function; whether the second terminal supports the ranging or SL positioning function; and whether the serving network of the second terminal supports the ranging or SL positioning function, where the second terminal is a reference terminal discovered by the first terminal to perform the ranging-related or SL positioning-related operation.

According to a fourth aspect, a ranging or sidelink SL positioning apparatus is provided. The apparatus includes: an obtaining module, configured to obtain first information; and a performing module, configured to perform a ranging-related or SL positioning-related operation based on the first information, where the first information is used to indicate at least one of the following: whether a serving network of a first terminal supports a ranging or SL positioning function; whether a second terminal supports the ranging or SL positioning function; and whether a serving network of the second terminal supports the ranging or SL positioning function, where the second terminal is a reference terminal discovered by the first terminal to perform the ranging-related or SL positioning-related operation.

According to a fifth aspect, a ranging or sidelink SL positioning apparatus is provided. The apparatus includes: a communication module, configured to: send first information to a first terminal, where the first information is used to perform a ranging-related or SL positioning-related operation; or receive first information from a first terminal; and perform a ranging-related or SL positioning-related operation based on the first information, where the first information is used to indicate at least one of the following: whether a serving network of the first terminal supports a ranging or SL positioning function; whether a second terminal supports the ranging or SL positioning function; and whether a serving network of the second terminal supports the ranging or SL positioning function, where the second terminal is a reference terminal discovered by the first terminal to perform the ranging-related or SL positioning-related operation.

According to a sixth aspect, a ranging or sidelink SL positioning apparatus is provided. The apparatus includes: a sending module, configured to: send first information to a first terminal, where the first information is used to perform a ranging-related or SL positioning-related operation; or send second information to a second terminal, where the second information is used to generate first information, the first information is used to perform a ranging-related or SL positioning-related operation, and the second information is used to indicate at least one of the following: whether the second terminal supports a function corresponding to a sidelink positioning server user equipment SL positioning server UE; whether a serving network of the second terminal supports a ranging or SL positioning function; whether the second terminal is within a service area; and whether the second terminal is within a restricted area; and the first information is used to indicate at least one of the following: whether a serving network of the first terminal supports the ranging or SL positioning function; whether the second terminal supports the ranging or SL positioning function; and whether the serving network of the second terminal supports the ranging or SL positioning function, where the second terminal is a reference terminal discovered by the first terminal to perform the ranging-related or SL positioning-related operation.

According to a seventh aspect, a first terminal is provided. The terminal includes a processor and a memory, where the memory stores a program or an instruction that is executable on the processor, and the program or the instruction is executed by the processor to implement the steps of the method according to the first aspect.

According to an eighth aspect, a first terminal is provided, including a processor and a communications interface. The processor is configured to: obtain first information; and perform a ranging-related or SL positioning-related operation based on the first information, where the first information is used to indicate at least one of the following: whether a serving network of the first terminal supports a ranging or SL positioning function; whether a second terminal supports the ranging or SL positioning function; and whether a serving network of the second terminal supports the ranging or SL positioning function, where the second terminal is a reference terminal discovered by the first terminal to perform the ranging-related or SL positioning-related operation.

According to a ninth aspect, a second terminal is provided. The terminal includes a processor and a memory, the memory stores a program or an instruction that is executable on the processor, and the program or the instruction is executed by the processor to implement the steps of the method according to the second aspect.

According to a tenth aspect, a second terminal is provided, including a processor and a communication interface. The communication interface is configured to: send first information to a first terminal, where the first information is used to perform a ranging-related or SL positioning-related operation; or receive first information from a first terminal; and perform a ranging-related or SL positioning-related operation based on the first information, where the first information is used to indicate at least one of the following: whether a serving network of the first terminal supports a ranging or SL positioning function; whether the second terminal supports the ranging or SL positioning function; and whether a serving network of the second terminal supports the ranging or SL positioning function, where the second terminal is a reference terminal discovered by the first terminal to perform the ranging-related or SL positioning-related operation.

According to an eleventh aspect, a network side device is provided. The network side device includes a processor and a memory, the memory stores a program or an instruction that is executable on the processor, and the program or the instruction is executed by the processor to implement the steps of the method according to the third aspect.

According to a twelfth aspect, a network side device is provided, including a processor and a communication interface. The communication interface is configured to: send first information to a first terminal, where the first information is used to perform a ranging-related or SL positioning-related operation; or send second information to a second terminal, where the second information is used to generate first information, the first information is used to perform a ranging-related or SL positioning-related operation, and the second information is used to indicate at least one of the following: whether the second terminal supports a function corresponding to a sidelink positioning server user equipment SL positioning server UE; whether a serving network of the second terminal supports a ranging or SL positioning function; whether the second terminal is within a service area; and whether the second terminal is within a restricted area; and the first information is used to indicate at least one of the following: whether a serving network of the first terminal supports the ranging or SL positioning function; whether the second terminal supports the ranging or SL positioning function; and whether the serving network of the second terminal supports the ranging or SL positioning function, where the second terminal is a reference terminal discovered by the first terminal to perform the ranging-related or SL positioning-related operation.

According to a thirteenth aspect, a readable storage medium is provided. A program or an instruction is stored on the readable storage medium, and the program or the instruction is executed by a processor to implement the steps of the method according to the first aspect, the steps of the method according to the second aspect, or the steps of the method according to the third aspect.

According to a fourteenth aspect, a wireless communication system is provided, including a first terminal, a second terminal, and a network side device. The first terminal may be configured to perform the steps of the method according to the first aspect, the second terminal may be configured to perform the steps of the method according to the second aspect, and the network side device may be configured to perform the steps of the method according to the third aspect.

According to a fifteenth aspect, a chip is provided. The chip includes a processor and a communication interface. The communication interface is coupled to the processor. The processor is configured to run a program or an instruction, to implement the steps of the method according to the first aspect, the steps of the method according to the second aspect, or the steps of the method according to the third aspect.

According to a sixteenth aspect, a computer program/program product is provided. The computer program/program product is stored in a storage medium, and the program/program product is executed by at least one processor to implement the steps of the ranging or sidelink SL positioning method according to the first aspect, or implement the steps of the ranging or sidelink SL positioning method according to the second aspect, or implement the steps of the ranging or sidelink SL positioning method according to the third aspect.

According to a seventeenth aspect, an embodiment of this application provides a ranging or sidelink SL positioning apparatus. The apparatus is configured to perform the ranging or sidelink SL positioning method according to the first aspect or the second aspect.

### BRIEF DESCRIPTION OF DRAWINGS

FIG. 1 is a schematic diagram of a wireless communication system to which embodiments of this application are applicable;

FIG. 2 is a first schematic flowchart of a ranging or SL positioning method according to an embodiment of this application;

FIG. 3 is a second schematic flowchart of a ranging or SL positioning method according to an embodiment of this application;

FIG. 4 is a third schematic flowchart of a ranging or SL positioning method according to an embodiment of this application;

FIG. 5 is a first signaling exchange diagram of a ranging or SL positioning method according to an embodiment of this application;

FIG. 6 is a second signaling exchange diagram of a ranging or SL positioning method according to an embodiment of this application;

FIG. 7 is a third signaling exchange diagram of a ranging or SL positioning method according to an embodiment of this application;

FIG. 8 is a fourth signaling exchange diagram of a ranging or SL positioning method according to an embodiment of this application;

FIG. 9 is a fifth signaling exchange diagram of a ranging or SL positioning method according to an embodiment of this application;

FIG. 10 is a sixth signaling exchange diagram of a ranging or SL positioning method according to an embodiment of this application;

FIG. 11 is a seventh signaling exchange diagram of a ranging or SL positioning method according to an embodiment of this application;

FIG. 12 is an eighth signaling exchange diagram of a ranging or SL positioning method according to an embodiment of this application;

FIG. 13 is a ninth signaling exchange diagram of a ranging or SL positioning method according to an embodiment of this application;

FIG. 14 is a tenth signaling exchange diagram of a ranging or SL positioning method according to an embodiment of this application;

FIG. 15 is an eleventh signaling exchange diagram of a ranging or SL positioning method according to an embodiment of this application;

FIG. 16 is a twelfth signaling exchange diagram of a ranging or SL positioning method according to an embodiment of this application;

FIG. 17 is a first schematic diagram of a structure of a ranging or SL positioning apparatus according to an embodiment of this application;

FIG. 18 is a second schematic diagram of a structure of a ranging or SL positioning apparatus according to an embodiment of this application;

FIG. 19 is a third schematic diagram of a structure of a ranging or SL positioning apparatus according to an embodiment of this application;

FIG. 20 is a schematic diagram of a structure of a communication device according to an embodiment of this application;

FIG. 21 is a schematic diagram of a hardware structure of a first terminal according to an embodiment of this application;

FIG. 22 is a schematic diagram of a hardware structure of a second terminal according to an embodiment of this application; and

FIG. 23 is a schematic diagram of a structure of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as "first" and "second" in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by "first" and "second" are usually of a same type, and a quantity of objects is not limited. For example, there may be one or more first objects. In addition, "or" in this application means at least one of the connected objects. For example, "A or B" includes three solutions, namely: solution 1: include A but exclude B; solution 2: include B but exclude A; solution 3: include both A and B. The character "/" usually indicates an "or" relationship between the associated objects.

The term "indication" in this application may be a direct indication (or explicit indication) or an indirect indication (or implicit indication). The direct indication may be understood as that a sender explicitly notifies a sent indication of content such as specific information, an operation that needs to be performed, or a request result to a receiver. The indirect indication may be understood as that the receiver determines corresponding information according to the indication sent by the sender, or performs determining according to the indication sent by the sender, and determines, according to a determining result, the operation that needs to be performed, the request result, or the like.

It should be noted that technologies described in the embodiments of this application are not limited to a Long Term Evolution (Long Term Evolution, LTE)/LTE-Advanced (LTE-Advanced, LTE-A) system, and may be further applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency-division multiple access (Single-carrier Frequency-Division Multiple Access, SC-FDMA), or other systems. The terms "system" and "network" in the embodiments of this application may be used interchangeably. The technologies described can be applied to both the systems and the radio technologies mentioned above as well as to other systems and radio technologies. A new radio (New Radio, NR) system is described in the following descriptions for illustrative purposes, and the NR terminology is used in most of the following descriptions, although these technologies can also be applied to a system other than the NR system, such as a 6^{th} generation (6^{th} Generation, 6G) communication system.

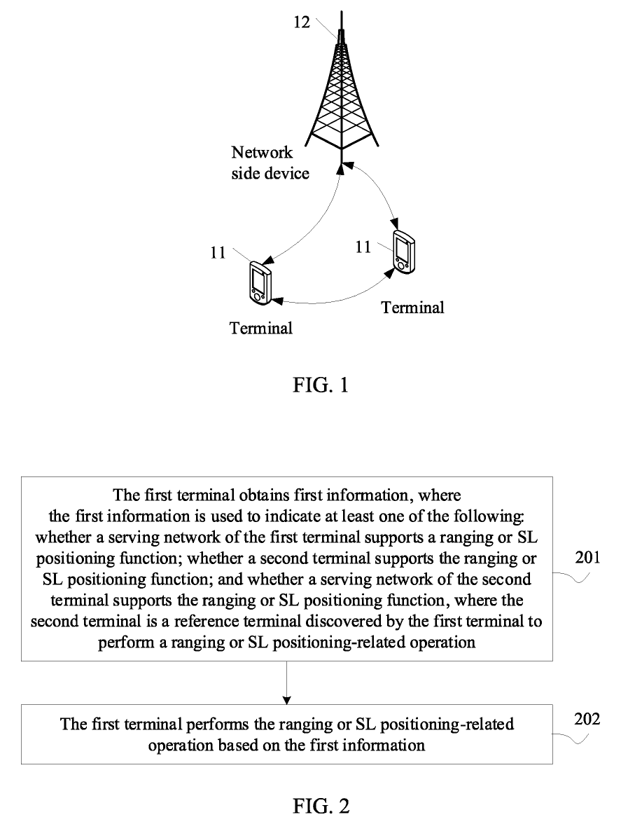

FIG. 1 is a schematic diagram of a wireless communication system to which embodiments of this application are applicable. The wireless communication system includes a terminal 11 and a network side device 12. The terminal 11 may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR) device, a virtual reality (Virtual Reality, VR) device, a robot, a wearable device (Wearable Device), a flight vehicle (flight vehicle), vehicle user equipment (Vehicle User Equipment, VUE), ship user equipment, pedestrian user equipment (Pedestrian User Equipment, PUE), a smart home (a home device with a wireless communication function, such as a refrigerator, a television, a washing machine, or a furniture), a game console, a personal computer (Personal Computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. The vehicle user equipment may also be referred to as a vehicle terminal, a vehicle controller, a vehicle module, a vehicle component, a vehicle chip, a vehicle unit, or the like. It should be noted that a specific type of the terminal 11 is not limited in the embodiments of this application.

The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), wireless fidelity (Wireless Fidelity, WiFi) node, or the like. The base station may be referred to as a NodeB (NodeB, NB), an evolved NodeB (Evolved NodeB, eNB), a next generation NodeB (the next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF), an edge application server discovery function (Edge Application Server Discovery Function, EASDF), a unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF), and the like. It should be noted that, in the embodiments of this application, only a core network device in an NR system is used as an example for description, and a specific type of the core network device is not limited.

To facilitate a clearer understanding of the technical solutions provided in the embodiments of this application, some relevant background knowledge is first described below.

(1) In scenarios of SL positioning and/or ranging, a target UE and a reference UE may not have a function of serving as an SL positioning server UE. In other words, the target UE and the reference UE may not have a function, such as a determining method for SL positioning and/or ranging, distribution of assistance data, or positioning calculation. In this case, the target UE or the reference UE needs to discover and select an SL positioning server UE to assist the target UE in implementing the foregoing function, and provides an SL positioning and/or ranging result of the target UE.

However, in a case that currently, one of the target UE or the reference UE is in coverage (in coverage) of a network, and a serving network thereof, such as a location management function (Location Management Function, LMF), supports an SL positioning and/or ranging function, there is no need to discover and select an SL positioning server UE. In a case that the SL positioning and/or ranging function is not supported, the SL positioning server UE is introduced. Herein, the following two problems arise:

A first problem is how the target UE determines that a discovered SL reference UE does not have a serving network.

A second problem is how the target UE determines that a serving network of the target UE does not support ranging or SL positioning, and how an SL reference UE discovered by the target UE determines that a serving network of the SL reference UE does not support ranging or SL positioning.

(2) SL positioning server UE

The SL positioning server UE refers to a UE used for a determining method based on an SL positioning and/or ranging service, distribution of assistance data, and/or a positioning calculation function. The SL positioning server UE interacts with another UE through a direct communication interface (PC5) when necessary, to determine the ranging or SL positioning method, distribute assistance data, and calculate a position of the target UE. In a case that all of the above functions are supported, the target UE or the SL reference UE may serve as the SL positioning server UE.

A ranging or SL positioning method and apparatus, and a storage medium provided in the embodiments of this application are described below in detail with reference to the accompanying drawings by using some embodiments and application scenarios thereof.

The ranging or SL positioning method provided in the embodiments of this application may be applied to a first terminal. The first terminal may serve as a target UE configured to perform a ranging-related or SL positioning-related operation.

FIG. 2 is a first schematic flowchart of a ranging or SL positioning method according to an embodiment of this application. As shown in FIG. 2, the method includes step 201 and step 202.

Step 201: A first terminal obtains first information, where the first information is used to indicate at least one of the following: whether a serving network of the first terminal supports a ranging or SL positioning function; whether a second terminal supports the ranging or SL positioning function; and whether a serving network of the second terminal supports the ranging or SL positioning function, where the second terminal is a reference terminal discovered by the first terminal to perform a ranging-related or SL positioning-related operation.

Step 202: The first terminal performs the ranging-related or SL positioning-related operation based on the first information.

It should be noted that this embodiment of this application may be applied to a scenario in which the ranging-related or SL positioning-related operation is performed. A terminal includes but is not limited to the type of the terminal 11 listed above, and a network side device includes but is not limited to the type of the network side device 12 listed above. This is not limited in this embodiment of this application.

In consideration of the following implementation, a target UE or a reference UE usually needs to discover and select an SL positioning server UE to assist the target UE in implementing the foregoing function, and provides an SL positioning and/or ranging result of the target UE. However, potential privacy and security risks may exist in this implementation.

In a case that the target UE or the reference UE discovered by the target UE has a serving network that supports the ranging or SL positioning function, in a ranging or SL positioning process, the SL positioning server UE may not be introduced for participation. This leads to the following two urgent problems to be resolved:

(1) How the target UE knows whether the serving network of the reference UE supports the ranging or SL positioning function.

(2) How the target UE or the reference UE knows whether its serving network supports the ranging or SL positioning function.

For the foregoing urgent problems to be resolved, this embodiment of this application provides the ranging or SL positioning method.

In this embodiment of this application, the first terminal may obtain the first information, where the first information may indicate whether at least one of the serving network of the first terminal, the second terminal, or the serving network of the second terminal supports the ranging or SL positioning function.

Optionally, the ranging or SL positioning function may include at least one of a determining method based on an SL positioning and/or ranging service, distribution of assistance data, and a positioning calculation function.

After obtaining the first information, the first terminal may perform the ranging-related or SL positioning-related operation based on the first information. It should be noted that the mentioned ranging operation may be specifically a ranging operation in an SL scenario.

In the ranging or SL positioning method provided in this embodiment of this application, the first terminal may learn of, based on the first information, whether the serving network of the first terminal, the second terminal, and the serving network of the second terminal support the ranging or SL positioning function, and then perform the ranging-related or SL positioning-related operation with reference to the first information. Compared with a case that the target UE or the reference UE directly discovers and selects the SL positioning server UE to assist the target UE in implementing the ranging or SL positioning function, in this application, the first terminal may refer to the first information to avoid a case that a new SL positioning server UE is introduced to perform the ranging-related or SL positioning-related operation in a case that the serving network of the first terminal, the second terminal, or the serving network of the second terminal supports the ranging or SL positioning function or the like. This effectively reduces potential privacy and security risks. In addition, the method in this embodiment can increase a success rate of a ranging and/or SL positioning process and/or improve efficiency of the ranging and/or SL positioning process.

The ranging-related or SL positioning-related operation is described below in detail.

Optionally, the ranging-related or SL positioning-related operation may include at least one of the following: 1) initiating a sidelink mobile originated location request (Mobile Originated Location Request, SL-MO-LR) to the serving network of the first terminal; 2) discovery and selection operations on a sidelink positioning server user equipment (SL Positioning Server UE); and 3) requesting positioning assistance data or positioning measurement information from the second terminal.

Optionally, an implementation in which the first terminal performs the ranging-related or SL positioning-related operation based on the first information may include:

(1) In a case that the first terminal does not support the ranging or SL positioning function, and the first information indicates that at least one of the second terminal, the serving network of the second terminal, and the serving network of the first terminal supports the ranging or SL positioning function, the first terminal performs at least one of the following operations: initiating the SL-MO-LR to the serving network of the first terminal; and requesting the positioning assistance data or the positioning measurement information from the second terminal.

Specifically, in the case that the first terminal does not support the ranging or SL positioning function, and the first information indicates that at least one of the second terminal, the serving network of the second terminal, and the serving network of the first terminal supports the ranging or SL positioning function, the first terminal may initiate the SL-MO-LR to the serving network of the first terminal, and may also request the positioning assistance data or the positioning measurement information from the second terminal. In this case, there is no need to perform the discovery and selection operations on the SL positioning server UE. In other words, in this case, there is no need to introduce the SL positioning server UE to perform ranging or SL positioning.

Optionally, in the case that the first terminal does not support the ranging or SL positioning function, and the first information indicates that at least one of the second terminal, the serving network of the second terminal, and the serving network of the first terminal supports the ranging or SL positioning function, the performing a ranging-related or SL positioning-related operation may further include at least one of the following:

1) In a case that the first terminal does not support the ranging or SL positioning function, and the first information indicates that the second terminal supports the ranging or SL positioning function, the first terminal requests the positioning assistance data or the positioning measurement information from the second terminal.

2) In a case that the first terminal does not support the ranging or SL positioning function, and the first information indicates that the serving network of the second terminal supports the ranging or SL positioning function, the first terminal requests the positioning assistance data or the positioning measurement information from the second terminal.

Specifically, in the case that the first terminal does not support the ranging or SL positioning function, and the first information indicates that the second terminal or the serving network of the second terminal supports the ranging or SL positioning function, the first terminal may request the positioning assistance data or the positioning measurement information from the second terminal, to perform ranging or SL positioning by using the positioning assistance data or the positioning measurement information of the second terminal.

3) In a case that the first terminal does not support the ranging or SL positioning function, and the first information indicates that the second terminal and the serving network of the second terminal do not support the ranging or SL positioning function and the serving network of the first terminal supports the ranging or SL positioning function, the first terminal initiates the SL-MO-LR to the serving network of the first terminal.

Specifically, in the case that the first terminal does not support the ranging or SL positioning function, and the first information indicates that only the serving network of the first terminal supports the ranging or SL positioning function, the first terminal may initiate the SL-MO-LR to the serving network of the first terminal, to perform ranging or SL positioning by using the serving network of the first terminal.

Optionally, in a case that the first information indicates that the serving network of the first terminal supports the ranging or SL positioning function, regardless of whether the second terminal and the serving network of the second terminal support the ranging or SL positioning function, the first terminal may preferentially initiate the SL-MO-LR to the serving network of the first terminal, to perform ranging or SL positioning preferentially by using the serving network of the first terminal.

(2) In a case that the first terminal does not support the ranging or SL positioning function, and the first information indicates that the second terminal, the serving network of the second terminal, and the serving network of the first terminal do not support the ranging or SL positioning function, the first terminal performs the discovery and selection operations on the SL positioning server UE.

Specifically, in the case that the first terminal does not support the ranging or SL positioning function, and the first information indicates that the second terminal, the serving network of the second terminal, and the serving network of the first terminal do not support the ranging or SL positioning function, that is, in the case that the first terminal, the serving network of the first terminal, the second terminal, and the serving network of the second terminal do not support the ranging or SL positioning function, the first terminal performs the discovery and selection operations on the SL positioning server UE, to introduce the new SL positioning server UE for ranging or SL positioning.

A manner in which the first terminal obtains the first information is described below in detail.

Optionally, an implementation in which the first terminal obtains the first information may include at least one of the following: (1) The first terminal receives the first information from the second terminal.

(2) The first terminal receives the first information from the network side device, where the network side device is related to the serving network of the first terminal.

Specifically, an obtaining source of the first information may be the second terminal or the network side device.

The first terminal may learn, from the first information from the second terminal, whether the second terminal supports the ranging or SL positioning function, and may also learn whether the serving network of the second terminal supports the ranging or SL positioning function.

Furthermore, because the network side device is related to the serving network of the first terminal, the first terminal may further learn, from the first information from the network side device, whether the serving network of the first terminal supports the ranging or SL positioning function.

Optionally, the network side device may include at least one of the following: a) an AMF; and b) an LMF.

In a case that the obtaining source of the first information is the second terminal, the second terminal may include the first information in a discovery message between the second terminal and the first terminal, or in a capability interaction process.

Optionally, an implementation in which the first terminal receives the first information from the second terminal may include at least one of the following:

1) The first terminal receives a discovery message from the second terminal, where the discovery message carries the first information, and the discovery message includes at least one of the following: an announcement message in a model (Model) A discovery (discovery) scenario, and a reply message in a model B discovery scenario.

Specifically, in model A discovery, the second terminal sends the announcement message (announcement message) to the first terminal. The announcement message may carry the first information.

In model B discovery, the first terminal may send a solicitation message (solicitation message) to the second terminal, and include the first information in the solicitation message. After the second terminal receives the solicitation message, there may be the following several cases:

Case 1: In a case that the first information carried in the solicitation message indicates that the serving network of the first terminal supports the ranging or SL positioning function, the second terminal may send a reply message to the first terminal without considering whether the serving network of the second terminal supports the ranging or SL positioning function. The reply message may carry the first information.

Case 2: In a case that the first information carried in the solicitation message indicates that the serving network of the first terminal does not support the ranging or SL positioning function, the second terminal may send a reply message to the first terminal in a case that the serving network of the second terminal supports the ranging or SL positioning function. The reply message may carry the first information, and the first information may indicate a function supported by the serving network of the second terminal.

2) The first terminal receives a capability interaction message from the second terminal, where the capability interaction message carries the first information, and the capability interaction message includes at least one of a capability response message and a capability providing message.

Specifically, there may be the following several cases in this embodiment of this application:

Case 1: The first terminal first sends a ranging or SL positioning capability request (Ranging/SL Positioning capability request) message to the second terminal, and then receives a ranging or SL positioning capability response (Ranging/SL Positioning capability response) message from the second terminal. The capability response message carries the first information.

Case 2: The first terminal receives a ranging or SL positioning capability providing (Ranging/SL Positioning capability providing) message from the second terminal. The capability providing message carries the first information.

In a case that the obtaining source of the first information is the network side device, optionally, an implementation in which the first terminal receives the first information from the network side device may include:

1) In a case that the first terminal sends a first registration request message to the network side device, the first terminal receives a first registration response message from the network side device, where the first registration request message carries first capability information corresponding to the first terminal, the first capability information is used to indicate a first capability supported by the first terminal in a ranging or SL positioning process, and the first registration response message carries the first information.

Specifically, in a stage of registering with the network side device, the first terminal may send the first registration request message to the network side device, where the first registration request message carries the first capability information corresponding to the first terminal. The network side device may further obtain first subscription information of the first terminal, where the first subscription information is used to indicate whether the ranging or SL positioning function of the first terminal is authorized. For example, the first subscription information may be obtained from a unified data management (Unified Data Management, UDM) function network element. Then, the network side device may generate the first information based on the first capability information and/or the first subscription information, and then send the first registration response message carrying the first information to the first terminal.

Optionally, the first capability may include a capability of serving as at least one of the following: a. a target UE; b. a reference UE; c. a client (client) UE; d. an SL positioning server UE; e. an SL located (located) UE; and f. an assistant (assistant) UE.

2) In a case that the first terminal sends an SL-MO-LR to the network side device, the first terminal receives a first response message from the network side device, where the first response message is used to indicate the first information.

Specifically, the first terminal may also send the SL-MO-LR to the network side device, and implicitly indicate the first information based on the first response message fed back by the network side device. Specifically, there may be the following two cases:

Case 1: In a case that the first response message for the SL-MO-LR is a reject message, the first information may be used to indicate that the serving network of the first terminal does not support the ranging or SL positioning function.

Case 2: In a case that the first response message for the SL-MO-LR is an accept message, the first information may be used to indicate that the serving network of the first terminal supports the ranging or SL positioning function.

The ranging or SL positioning method provided in this embodiment of this application may be further applied to the second terminal. In a case that the first terminal serves as the target UE configured to perform the ranging-related or SL positioning-related operation, the second terminal is the reference terminal discovered by the first terminal to perform the ranging-related or SL positioning-related operation.

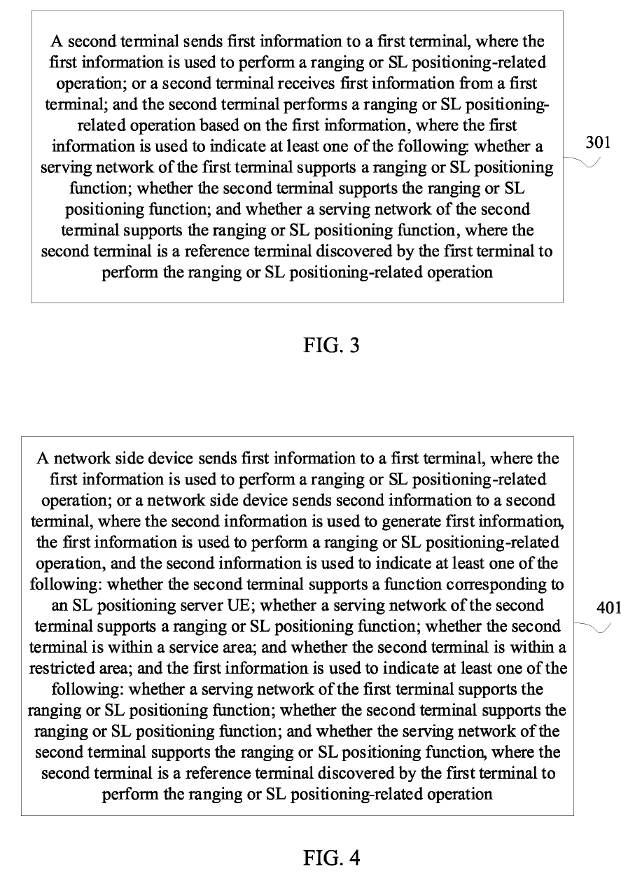

FIG. 3 is a second schematic flowchart of a ranging or SL positioning method according to an embodiment of this application. As shown in FIG. 3, the method includes step 301.

Step 301: A second terminal sends first information to a first terminal, where the first information is used to perform a ranging-related or SL positioning-related operation; or a second terminal receives first information from a first terminal; and the second terminal performs a ranging-related or SL positioning-related operation based on the first information, where the first information is used to indicate at least one of the following: whether a serving network of the first terminal supports a ranging or SL positioning function; whether the second terminal supports the ranging or SL positioning function; and whether a serving network of the second terminal supports the ranging or SL positioning function, where the second terminal is a reference terminal discovered by the first terminal to perform the ranging-related or SL positioning-related operation.

Specifically, there may be the following two cases in this embodiment of this application:

Case 1: The second terminal sends the first information to the first terminal. The first terminal performs the ranging-related or SL positioning-related operation based on the first information.

Case 2: The second terminal may alternatively receive the first information from the first terminal, and then perform the ranging-related or SL positioning-related operation based on the first information.

In the ranging or SL positioning method provided in this embodiment of this application, the second terminal may send the first information to the first terminal, or receive the first information from the first terminal, and perform the ranging-related or SL positioning-related operation based on the first information. The first terminal or the second terminal may learn of, based on the first information, whether the serving network of the first terminal, the second terminal, and the serving network of the second terminal support the ranging or SL positioning function, and then perform the ranging-related or SL positioning-related operation with reference to the first information. Compared with a related technology in which a target UE or a reference UE directly discovers and selects an SL positioning server UE to assist the target UE in implementing the ranging or SL positioning function, in this application, the first terminal or the second terminal may refer to the first information to avoid a case that a new SL positioning server UE is introduced to perform the ranging-related or SL positioning-related operation in a case that the serving network of the first terminal, the second terminal, or the serving network of the second terminal supports the ranging or SL positioning function or the like. This effectively reduces potential privacy and security risks. In addition, the method in this embodiment can increase a success rate of a ranging and/or SL positioning process and/or improve efficiency of the ranging and/or SL positioning process.

Optionally, an implementation in which the second terminal sends the first information to the first terminal may include at least one of the following:

1) The second terminal sends a discovery message to the first terminal, where the discovery message carries the first information, and the discovery message includes at least one of the following: an announcement message in a model A discovery scenario, and a reply message in a model B discovery scenario.

2) The second terminal sends a capability interaction message to the first terminal, where the capability interaction message carries the first information, and the capability interaction message includes at least one of a capability response message and a capability providing message.

Optionally, an implementation in which the second terminal receives the first information from the first terminal may include:

The second terminal receives a positioning assistance data request or a positioning measurement information request from the first terminal, where the positioning assistance data request or the positioning measurement information request carries the first information.

Specifically, the first terminal may send the positioning assistance data request or the positioning measurement information request to the second terminal carrying the first information. Further, the second terminal may perform the ranging-related or SL positioning-related operation based on the first information.

Optionally, an implementation in which the second terminal performs a ranging-related or SL positioning-related operation based on the first information may include:

1) In a case that the first information only indicates that the serving network of the first terminal does not support the ranging or SL positioning function, the second terminal initiates an SL-MO-LR to the serving network of the second terminal.

Specifically, in the case that the first information only indicates that the serving network of the first terminal does not support the ranging or SL positioning function, the second terminal initiates the SL-MO-LR to the serving network of the second terminal, to determine whether the serving network of the second terminal supports the ranging or SL positioning function. In a case that an accept message is received, it indicates that the serving network of the second terminal supports the ranging or SL positioning function. In a case that a reject message is received, it indicates that the serving network of the second terminal does not support the ranging or SL positioning function.

Optionally, in a case that the second terminal determines that the serving network of the second terminal supports the ranging or SL positioning function, the serving network of the second terminal performs ranging or SL positioning. In a case that the second terminal determines that the serving network of the second terminal does not support the ranging or SL positioning function, the second terminal may perform the discovery and selection operations on the SL positioning server UE, to use the SL positioning server UE for ranging or SL positioning.

2) In a case that the first information indicates that the serving network of the first terminal and the serving network of the second terminal do not support the ranging or SL positioning function, the second terminal performs discovery and selection operations on an SL positioning server UE.

Specifically, in the case that the first information indicates that the serving network of the first terminal and the serving network of the second terminal do not support the ranging or SL positioning function, the second terminal may directly perform the discovery and selection operations on the SL positioning server UE, to use the SL positioning server UE for ranging or SL positioning.

Optionally, the second terminal may obtain second information.

The second terminal generates the first information based on the second information, where the second information is used to indicate at least one of the following: a. whether the second terminal supports a function corresponding to the SL positioning server UE; b. whether the serving network of the second terminal supports the ranging or SL positioning function; c. whether the second terminal is within a service area; and d. whether the second terminal is within a restricted area.

Optionally, an implementation in which the second terminal generates the first information based on the second information may include:

1) In a case that the second information indicates that the second terminal supports the function corresponding to the SL positioning server UE, the second terminal generates the first information used to indicate that the second terminal supports the ranging or SL positioning function.

2) In a case that the second information indicates that the second terminal does not support the function corresponding to the SL positioning server UE, the second terminal generates the first information used to indicate that the second terminal does not support the ranging or SL positioning function.

3) In a case that the second information indicates that the serving network of the second terminal supports the ranging or SL positioning function, the second terminal generates the first information used to indicate that the serving network of the second terminal supports the ranging or SL positioning function.

4) In a case that the second information indicates that the serving network of the second terminal does not support the ranging or SL positioning function, the second terminal generates the first information used to indicate that the serving network of the second terminal does not support the ranging or SL positioning function.

5) In a case that the second information indicates that the second terminal is not within the service area, the second terminal generates the first information used to indicate that the serving network of the second terminal does not support the ranging or SL positioning function.

6) In a case that the second information indicates that the second terminal is within the restricted area, the second terminal generates the first information used to indicate that the serving network of the second terminal does not support the ranging or SL positioning function.

Specifically, in a case that the second terminal is within the restricted area, it may be considered that the serving network of the second terminal does not support the ranging or SL positioning function. Therefore, the first information used to indicate that the serving network of the second terminal does not support the ranging or SL positioning function may be generated based on this.

Optionally, an implementation in which the second terminal obtains the second information may include:

1) In a case that the second terminal sends a second registration request message to a network side device, the second terminal receives a second registration response message from the network side device, where the network side device is related to the serving network of the second terminal, the second registration request message carries second capability information corresponding to the second terminal, the second capability information is used to indicate a second capability supported by the second terminal in a ranging or SL positioning process, and the second registration response message carries the second information.

Specifically, in a stage of registering with the network side device, the second terminal may send the second registration request message to the network side device, where the second registration request message carries the second capability information corresponding to the second terminal. The network side device may further obtain second subscription information of the second terminal, where the second subscription information is used to indicate whether the ranging or SL positioning function of the second terminal is authorized. For example, the second subscription information may be obtained from a UDM function network element. Then, the network side device may generate the second information based on the second capability information and/or the second subscription information, and then send the second registration response message carrying the second information to the second terminal.

Optionally, the network side device may include at least one of the following: a) an AMF; and b) an LMF.

Optionally, the second capability may include a capability of serving as at least one of the following: a. a target UE; b. a reference UE; c. a client UE; d. an SL positioning server UE; e. an SL located UE; and f. an assistant UE. 2) In a case that the second terminal sends an SL-MO-LR to the network side device, the second terminal receives a second response message from the network side device, where the network side device is related to the serving network of the second terminal, and the second response message is used to indicate the second information.

Specifically, the second terminal may also send the SL-MO-LR to the network side device, and implicitly indicate the second information based on the second response message fed back by the network side device. Specifically, there may be the following two cases:

Case 1: In a case that the second response message for the SL-MO-LR is a reject message, the second information may be used to indicate that the serving network of the second terminal does not support the ranging or SL positioning function.

Case 2: In a case that the second response message for the SL-MO-LR is an accept message, the second information may be used to indicate that the serving network of the second terminal supports the ranging or SL positioning function.

The ranging or SL positioning method provided in this embodiment of this application may be further applied to the network side device, for example, at least one of the AMF and the LMF.

FIG. 4 is a third schematic flowchart of a ranging or SL positioning method according to an embodiment of this application. As shown in FIG. 4, the method includes step 401.

Step 401: A network side device sends first information to a first terminal, where the first information is used to perform a ranging-related or SL positioning-related operation; or a network side device sends second information to a second terminal, where the second information is used to generate first information, the first information is used to perform a ranging-related or SL positioning-related operation, and the second information is used to indicate at least one of the following: whether the second terminal supports a function corresponding to an SL positioning server UE; whether a serving network of the second terminal supports a ranging or SL positioning function; whether the second terminal is within a service area; and whether the second terminal is within a restricted area; and the first information is used to indicate at least one of the following: whether a serving network of the first terminal supports the ranging or SL positioning function; whether the second terminal supports the ranging or SL positioning function; and whether the serving network of the second terminal supports the ranging or SL positioning function, where the second terminal is a reference terminal discovered by the first terminal to perform the ranging-related or SL positioning-related operation.

Specifically, there may be the following two cases in this embodiment of this application: Case 1: The network side device sends the first information to the first terminal, and then the first terminal performs the ranging-related or SL positioning-related operation based on the first information.

Case 2: The network side device sends the second information to the second terminal, and then the second terminal generates the first information based on the second information. Further, the first terminal or the second terminal performs the ranging-related or SL positioning-related operation based on the first information.

In the ranging or SL positioning method provided in this embodiment of this application, the network side device may send the first information to the first terminal, or send the second information used to generate the first information to the second terminal. Further, the first terminal or the second terminal may learn of, based on the first information, whether the serving network of the first terminal, the second terminal, and the serving network of the second terminal support the ranging or SL positioning function, and then perform the ranging-related or SL positioning-related operation with reference to the first information. Compared with a related technology in which a target UE or a reference UE directly discovers and selects an SL positioning server UE to assist the target UE in implementing the ranging or SL positioning function, in this application, the first terminal or the second terminal may refer to the first information to avoid a case that a new SL positioning server UE is introduced to perform the ranging-related or SL positioning-related operation in a case that the serving network of the first terminal, the second terminal, or the serving network of the second terminal supports the ranging or SL positioning function or the like. This effectively reduces potential privacy and security risks.

For the first terminal, optionally, the network side device may receive a first registration request message from the first terminal, where the first registration request message carries first capability information corresponding to the first terminal, the first capability information is used to indicate a first capability supported by the first terminal in a ranging or SL positioning process.

The network side device generates the first information based on the first capability information and/or first subscription information, where the first subscription information is used to indicate whether the ranging or SL positioning function of the first terminal is authorized.

An implementation in which the network side device sends the first information to the first terminal may include: The network side device sends a first registration response message to the first terminal, where the first registration response message carries the first information.

For example, the AMF may send, based on the first capability information reported by the first terminal through the first registration request message, and ranging or SL positioning subscription information (the first subscription information) of the first terminal, the first registration response message carrying the first information to the first terminal. The first information may be used to indicate whether the serving network of the first terminal supports the ranging or SL positioning function.

In one embodiment, the AMF may send the first information to the first terminal in a case that the first capability information indicates that the first terminal supports the ranging or SL positioning function, and the first subscription information indicates that the ranging or SL positioning function of the first terminal has been authorized.

Optionally, the first subscription information may be obtained by the network side device from a UDM function network element.

Optionally, the first capability may include a capability of serving as at least one of the following: a. a target UE; b. a reference UE; c. a client UE; d. an SL positioning server UE; e. an SL located UE; and f. an assistant UE.

For the first terminal, optionally, the network side device may further receive an SL-MO-LR from first terminal.

An implementation in which the network side device sends the first information to the first terminal may include:

The network side device sends a first response message to the first terminal, where the first response message is used to indicate the first information.

For example, the AMF or the LMF may receive the SL-MO-LR from the first terminal. The SL-MO-LR is accepted or rejected to implicitly indicate whether the serving network of the first terminal supports the ranging or SL positioning function.

For the second terminal, optionally, the network side device may receive a second registration request message from the second terminal, where the second registration request message carries second capability information corresponding to the second terminal, and the second capability information is used to indicate a second capability supported by the second terminal in a ranging or SL positioning process.

The network side device generates the second information based on the second capability information and/or second subscription information, where the second subscription information is used to indicate whether the ranging or SL positioning function of the second terminal is authorized.

An implementation in which the network side device sends the second information to the second terminal may include:

The network side device sends a second registration response message to the second terminal, where the second registration response message carries the second information.

For example, the AMF may send, based on the second capability information reported by the second terminal through the second registration request message, and ranging or SL positioning subscription information (the second subscription information) of the second terminal, the second registration response message carrying the second information to the second terminal. The second information may be used to indicate whether the serving network of the second terminal supports the ranging or SL positioning function.

In one embodiment, the AMF may send the second information to the second terminal in a case that the second capability information indicates that the second terminal supports the ranging or SL positioning function, and the second subscription information indicates that the ranging or SL positioning function of the second terminal has been authorized.

Optionally, the second subscription information may be obtained by the network side device from the UDM function network element.

Optionally, the second capability may include a capability of serving as at least one of the following: a. a target UE; b. a reference UE; c. a client UE; d. an SL positioning server UE; e. an SL located UE; and f. an assistant UE.

For the second terminal, optionally, the network side device may further receive an SL-MO-LR from the second terminal.

An implementation in which the network side device sends the second information to the second terminal may include:

The network side device sends a second response message to the second terminal, where the second response message is used to indicate the second information.

For example, the AMF or the LMF may receive the SL-MO-LR from the second terminal. The SL-MO-LR is accepted or rejected to implicitly indicate whether the serving network of the second terminal supports the ranging or SL positioning function.

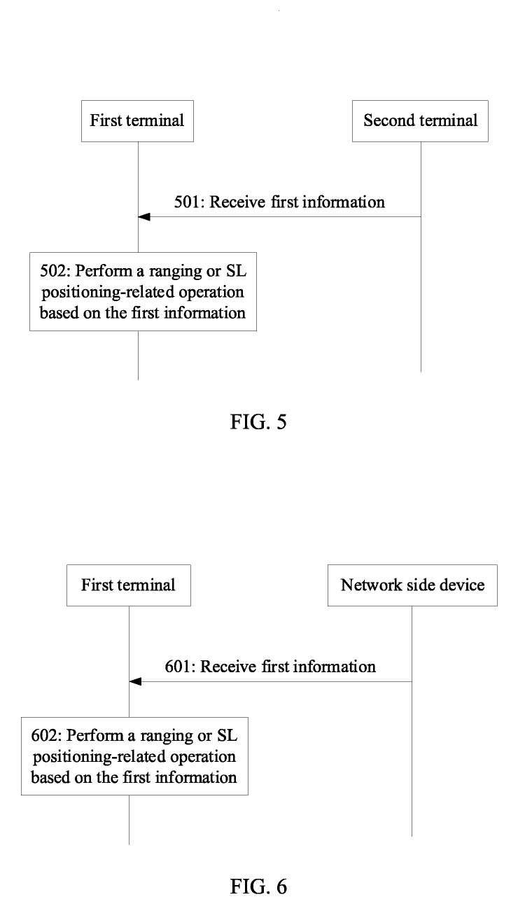

FIG. 5 is a first signaling exchange diagram of a ranging or SL positioning method according to an embodiment of this application. As shown in FIG. 5, the method includes step 501 and step 502.

Step 501: A first terminal receives first information from a second terminal.

Step 502: The first terminal performs a ranging-related or SL positioning-related operation based on the first information.

The first information is used to indicate at least one of the following:

1) whether a serving network of the first terminal supports a ranging or SL positioning function; 2) whether a second terminal supports the ranging or SL positioning function; and 3) whether a serving network of the second terminal supports the ranging or SL positioning function, where the second terminal is a reference terminal discovered by the first terminal to perform the ranging-related or SL positioning-related operation.

FIG. 6 is a second signaling exchange diagram of a ranging or SL positioning method according to an embodiment of this application. As shown in FIG. 6, the method includes step 601 and step 602.

Step 601: A first terminal receives first information from a network side device, where the network side device is related to a serving network of the first terminal.

Step 602: The first terminal performs a ranging-related or SL positioning-related operation based on the first information.

The first information is used to indicate at least one of the following: 1) whether the serving network of the first terminal supports a ranging or SL positioning function; 2) whether a second terminal supports the ranging or SL positioning function; and 3) whether a serving network of the second terminal supports the ranging or SL positioning function, where the second terminal is a reference terminal discovered by the first terminal to perform the ranging-related or SL positioning-related operation.

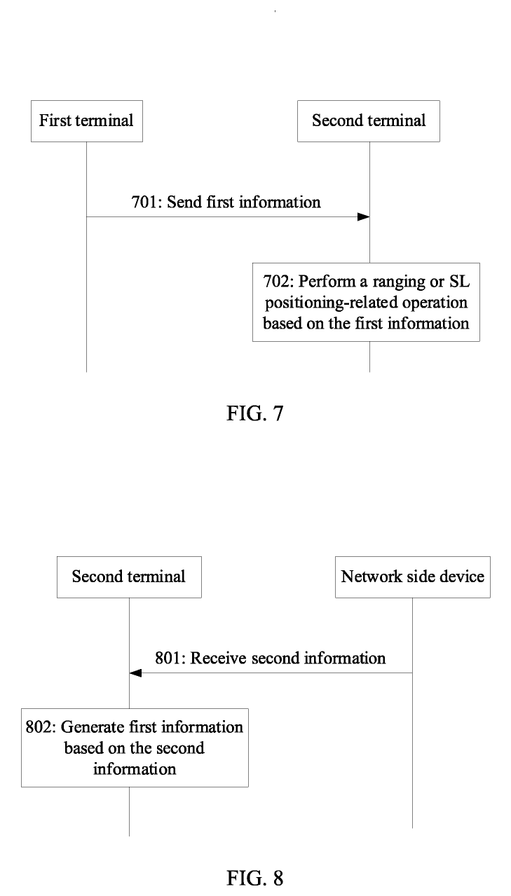

FIG. 7 is a third signaling exchange diagram of a ranging or SL positioning method according to an embodiment of this application. As shown in FIG. 7, the method includes step 701 and step 702.

Step 701: A first terminal sends first information to a second terminal.

Step : 702The second terminal performs a ranging-related or SL positioning-related operation based on the first information.

The first information is used to indicate at least one of the following: 1) whether a serving network of the first terminal supports a ranging or SL positioning function; 2) whether the second terminal supports the ranging or SL positioning function; and 3) whether a serving network of the second terminal supports the ranging or SL positioning function, where the second terminal is a reference terminal discovered by the first terminal to perform the ranging-related or SL positioning-related operation.

FIG. 8 is a fourth signaling exchange diagram of a ranging or SL positioning method according to an embodiment of this application. As shown in FIG. 8, the method includes step 801 and step 802.

Step 801: A second terminal receives second information from a network side device, where the second information is used to generate first information, and the first information is used to perform a ranging-related or SL positioning-related operation.

Step 802: The second terminal generates the first information based on the second information.

Specifically, the second information is used to indicate at least one of the following: whether the second terminal supports a function corresponding to an SL positioning server UE; whether a serving network of the second terminal supports a ranging or SL positioning function; whether the second terminal is within a service area; and whether the second terminal is within a restricted area.

The first information is used to indicate at least one of the following: 1) whether a serving network of a first terminal supports the ranging or SL positioning function; 2) whether the second terminal supports the ranging or SL positioning function; and 3) whether the serving network of the second terminal supports the ranging or SL positioning function, where the second terminal is a reference terminal discovered by the first terminal to perform the ranging-related or SL positioning-related operation.

The ranging or SL positioning method provided in this embodiment of this application is described below by using an example.

(1) In a registration stage, the AMF sends the first information to the first terminal or sends the second information to the second terminal based on ranging or SL positioning capability information (first capability information or second capability information) reported by the terminal (first terminal or second terminal), and ranging or SL positioning subscription information (first subscription information or second subscription information) of the terminal. The first information is used to indicate that the serving network of the first terminal or the second terminal supports or does not support the ranging or SL positioning function.

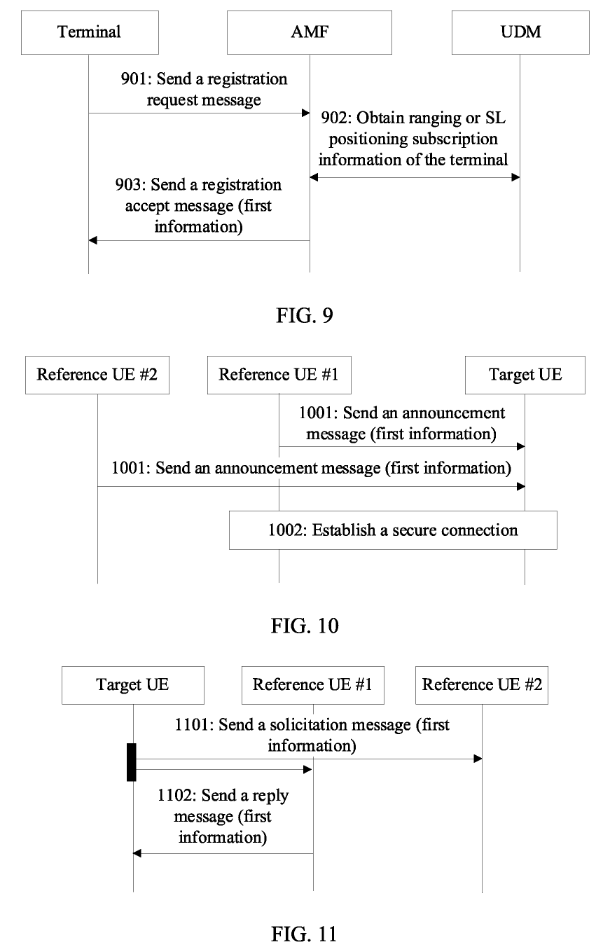

FIG. 9 is a fifth signaling exchange diagram of a ranging or SL positioning method according to an embodiment of this application. As shown in FIG. 9, the method includes step 901 to step 903.

Step 901: A terminal sends a registration request message to an AMF, where the registration request message carries ranging or SL positioning capability information of the terminal.

Specifically, the terminal sends the registration request message to the AMF. The registration request message carries the ranging or SL positioning capability information of the terminal, including at least one of the following: a) as a target UE in a ranging or SL positioning process; b) as a reference UE in the ranging or SL positioning process; c) as an SL positioning server UE in the ranging or SL positioning process; d) as an SL located UE in the ranging or SL positioning process; and e) as an assistant UE in the ranging or SL positioning process.

Step 902: The AMF obtains ranging or SL positioning subscription information of the terminal from a UDM based on NUDM_SDM_GET information.

Specifically, the AMF obtains the ranging or SL positioning subscription information of the terminal from the UDM, to determine whether a ranging or SL positioning function is authorized to the terminal.

Step 903: The AMF sends a registration accept message to the terminal, where the registration accept message carries first information.

Specifically, the AMF determines to send the first information to the terminal according to the ranging or SL positioning capability information reported by the terminal, and/or the ranging or SL positioning subscription information in the UDM. The first information is used to indicate that a serving network of the terminal supports or does not support the ranging or SL positioning function.

For example, a) in a case that the terminal reports the ranging or SL positioning capability information, the AMF sends the first information; and b) in a case that the AMF determines, according to the subscription information, that the ranging or SL positioning function has been authorized to the terminal, the AMF sends the first information.

(2) The second terminal includes the first information in a discovery message. The first terminal determines, according to the first information, whether to select the second terminal to establish a secure connection.

In model A discovery, FIG. 10 is a sixth signaling exchange diagram of a ranging or SL positioning method according to an embodiment of this application. As shown in FIG. 10, the method includes step 1001 and step 1002.

Step 1001: A reference UE #1 and a reference UE #2 (second terminal) send an announcement message (announcement message) to a target UE (first terminal), where the announcement message carries first information.

Step 1002: The target UE selects to establish a secure connection to the reference UE #1 based on the first information.

Specifically, in model A discovery, the second terminal includes the first information in the discovery message.

1) The reference UE #1 and the reference UE #2 send the announcement message to the target UE, where the announcement message carries the first information. The first information is used to indicate that a serving network of the second terminal supports or does not support a ranging or SL positioning function.

2) The first terminal selects the reference UE #1 based on the first information and establishes the secure connection to the reference UE #1, such as, establishes a unicast connection.

In one embodiment, the first information corresponding to the reference UE #1 is used to indicate that a serving network of the reference UE #1 supports the ranging or SL positioning function or a serving network of the reference UE #1 does not support the ranging or SL positioning function.

In model B discovery, FIG. 11 is a seventh signaling exchange diagram of a ranging or SL positioning method according to an embodiment of this application. As shown in FIG. 11, the method includes step 1101 and step 1102.

Step 1101: A target UE (first terminal) sends a solicitation message (solicitation message) to a reference UE #1 and a reference UE #2 (second terminal), where the solicitation message carries first information.

Step 1102: The reference UE #1 and the reference UE #2 select, according to the carried first information, whether to send a reply message to the target UE.

Specifically, in model B discovery, the first terminal includes the first information in the solicitation message.

1) The target UE sends the solicitation message (solicitation message), where the message carries the first information. 2) The reference UE determines, according to the carried first information, to reply to the target UE, including: a. In a case that the first information indicates that a serving network of the first terminal supports a ranging or SL positioning function, the reference UE does not consider whether a serving network of the reference UE supports the function, and sends a reply message to the target UE, where the reply message optionally carries the first information of the reference UE.

b. In a case that the first information indicates that the serving network of the first terminal does not support the ranging or SL positioning function, the reference UE #1 sends a reply message to the target UE in a case that the serving network of the reference UE #1 supports the ranging or SL positioning function, where the reply message optionally carries the first information indicating that the serving network supports the ranging or SL positioning function.

(3) Whether the serving network supports the ranging or SL positioning function is added in a capability interaction process between the first terminal and the second terminal.

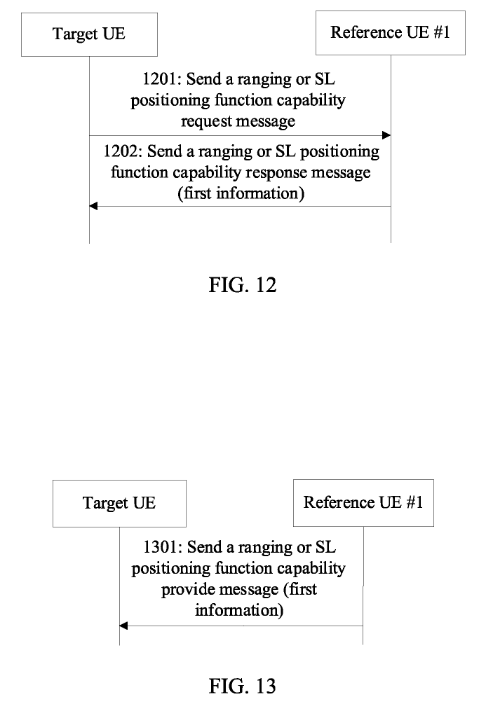

FIG. 12 is an eighth signaling exchange diagram of a ranging or SL positioning method according to an embodiment of this application. As shown in FIG. 12, the method includes step 1201 and step 1202.

Step 1201: A target UE sends a ranging or SL positioning capability request (Ranging/SL Positioning capability request) message to a reference UE #1.

Step 1202: The reference UE #1 sends a ranging or SL positioning capability response (Ranging/SL Positioning capability response) message to the target UE, where the capability response message carries first information.

FIG. 13 is a ninth signaling exchange diagram of a ranging or SL positioning method according to an embodiment of this application. As shown in FIG. 13, the method includes step 1301.

Step 1301: A reference UE #1 sends a ranging or SL positioning capability provide (Ranging/SL Positioning capability provide) message to a target UE, where the capability providing message carries first information.

(4) The terminal determines, based on feedback of the network, whether the network supports the ranging or SL positioning function.

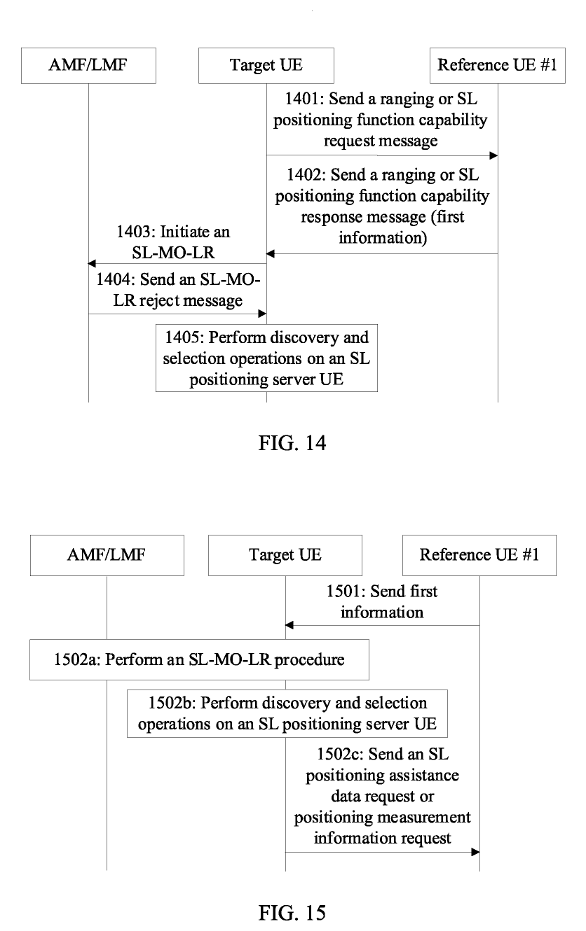

FIG. 14 is a tenth signaling exchange diagram of a ranging or SL positioning method according to an embodiment of this application. As shown in FIG. 14, the method includes step 1401 to step 1405.

Step 1401: A target UE sends a ranging or SL positioning capability request message to a reference UE #1.

Step 1402: The reference UE #1 sends a ranging or SL positioning capability response message to the target UE, where the capability response message carries first information, and the first information is used to indicate that the reference UE #1 and/or a serving network of the reference UE #1 do/does not support a ranging or SL positioning function.

Step 1403: The target UE initiates an SL-MO-LR to an AMF/LMF.

Step 1404: The AMF/LMF sends an SL-MO-LR reject message to the target UE.

Step 1405: The target UE performs discovery and selection operations on an SL positioning server UE.

(5) The first terminal performs the ranging-related or SL positioning-related operation based on the first information.

FIG. 15 is an eleventh signaling exchange diagram of a ranging or SL positioning method according to an embodiment of this application. As shown in FIG. 15, the method includes step 1501, step 1502a, step 1502b, and step 1502c.

Step 1501: A reference UE #1 sends first information to a target UE.

Step 1502a: The target UE performs an SL-MO-LR procedure (procedure) with an AMF/LMF.

Step 1502b: The target UE performs discovery and selection operations on an SL positioning server UE.

Step 1502c: The target UE sends an SL positioning assistance data request or positioning measurement information request to the reference UE #1.

It should be noted that steps 1502a, step 1502b, and step 1502c mentioned above are all optional steps.

For example, in a case that the first information in step 1501 is used to indicate that the reference UE #1 and/or a serving network of the reference UE #1 support/supports a ranging or SL positioning function, step 1502c may be directly performed, to use the reference UE #1 or the serving network of the reference UE #1 for ranging or SL positioning.

In a case that the first information in step 1501 is used to indicate that the reference UE #1 and the serving network of the reference UE #1 do not support the ranging or SL positioning function, step 1502a may continue to be performed. The target UE determines, with the AMF/LMF through an SL-MO-LR, whether a serving network of the target UE supports the ranging or SL positioning function. In a case that the ranging or SL positioning function is supported, there is no need to continue to perform step 1502b. In a case that the ranging or SL positioning function is not supported, step 1502b continues to be performed.

(6) After the first terminal sends the positioning assistance data request or the positioning measurement information request to the second terminal, the second terminal performs the ranging-related or SL positioning-related operation based on the first information carried in the positioning assistance data request or the positioning measurement information request.

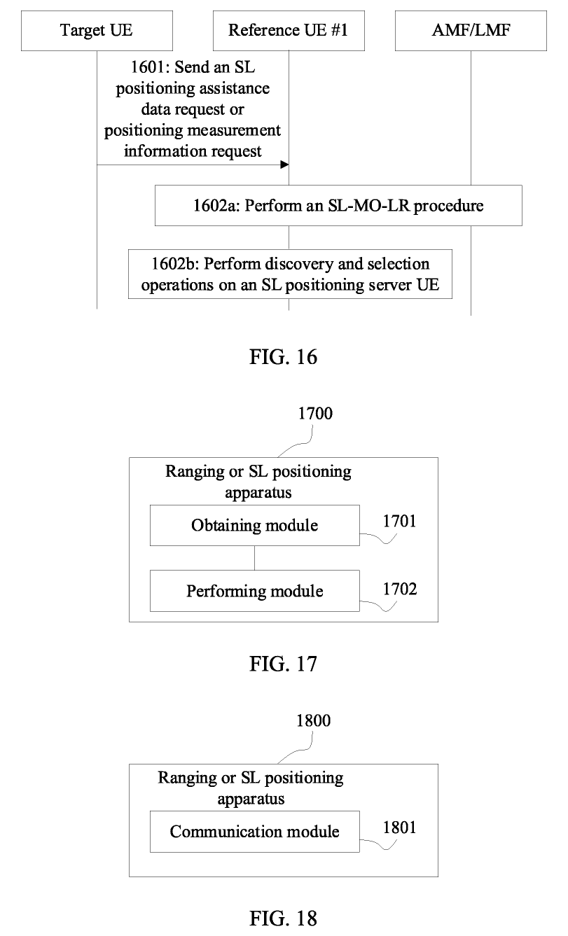

FIG. 16 is a twelfth signaling exchange diagram of a ranging or SL positioning method according to an embodiment of this application. As shown in FIG. 16, the method includes step 1601, step 1602a, and step 1602b.

Step 1601: A target UE sends an SL positioning assistance data request or positioning measurement information request to a reference UE #1.

Step 1602a: The reference UE #1 performs an SL-MO-LR procedure with an AMF/LMF.

Step 1602b: The reference UE #1 performs discovery and selection operations on an SL positioning server UE.

It should be noted that step 1602b is an optional step. In a case that in step 1602a, the reference UE #1 determines, through the SL-MO-LR procedure, that a serving network of the reference UE#1 supports a ranging or SL positioning function, step 1602b does not need to be performed. In a case that the reference UE #1 determines, through the SL-MO-LR procedure, that the serving network of the reference UE #1 does not support the ranging or SL positioning function, step 1602b is performed.

In this embodiment of this application, the terminal may include, in a discovery message, first information indicating that a serving network supports or does not support the ranging or SL positioning function. An AMF may also send the first information indicating that the serving network supports or does not support the ranging or SL positioning function to the terminal according to ranging or SL positioning capability information of the terminal. This avoids a case that the SL positioning server UE is introduced for ranging or SL positioning in a case that the serving network supports the ranging or SL positioning function, to effectively reduce potential privacy and security risks of ranging or SL positioning.

The ranging or SL positioning method provided in the embodiments of this application may be performed by a ranging or SL positioning apparatus. In the embodiments of this application, an example in which the ranging or SL positioning apparatus performs the ranging or SL positioning method is used to describe the ranging or SL positioning apparatus provided in the embodiments of this application.

FIG. 17 is a first schematic diagram of a structure of a ranging or SL positioning apparatus according to an embodiment of this application. As shown in FIG. 17, the ranging or SL positioning apparatus 1700 includes: an obtaining module 1701, configured to obtain first information; and the first information is used to indicate at least one of the following: 1) whether a serving network of a first terminal supports a ranging or SL positioning function; 2) whether a second terminal supports the ranging or SL positioning function; and 3) whether a serving network of the second terminal supports the ranging or SL positioning function, where the second terminal is a reference terminal discovered by the first terminal to perform the ranging-related or SL positioning-related operation.

a performing module 1702, configured to perform a ranging-related or SL positioning-related operation based on the first information, where

In the ranging or SL positioning apparatus provided in this embodiment of this application, the obtaining module may learn of, based on the first information, whether the serving network of the first terminal, the second terminal, and the serving network of the second terminal support the ranging or SL positioning function, and then the performing module performs the ranging-related or SL positioning-related operation with reference to the first information. Compared with a related technology in which a target UE or a reference UE directly discovers and selects an SL positioning server UE to assist the target UE in implementing the ranging or SL positioning function, in this application, the first information is referred to, to avoid a case that a new SL positioning server UE is introduced to perform the ranging-related or SL positioning-related operation in a case that the serving network of the first terminal, the second terminal, or the serving network of the second terminal supports the ranging or SL positioning function or the like. This effectively reduces potential privacy and security risks.

Optionally, the ranging-related or SL positioning-related operation includes at least one of the following: 1) initiating an SL-MO-LR to the serving network of the first terminal; 2) discovery and selection operations on an SL positioning server UE; and 3) requesting positioning assistance data or positioning measurement information from the second terminal.

Optionally, the obtaining module 1701 is specifically configured to perform at least one of the following: (1) receiving the first information from the second terminal; and (2) receiving the first information from a network side device, where the network side device is related to the serving network of the first terminal.

Optionally, the obtaining module 1701 is further specifically configured to perform at least one of the following: 1) receiving a discovery message from the second terminal, where the discovery message carries the first information, and the discovery message includes at least one of the following: an announcement message in a model A discovery scenario, and a reply message in a model B discovery scenario; and 2) receiving a capability interaction message from the second terminal, where the capability interaction message carries the first information, and the capability interaction message includes at least one of a capability response message and a capability providing message.

Optionally, the obtaining module 1701 is further specifically configured to: 1) in a case that the first terminal sends a first registration request message to the network side device, receive a first registration response message from the network side device, where the first registration request message carries first capability information corresponding to the first terminal, the first capability information is used to indicate a first capability supported by the first terminal in a ranging or SL positioning process, and the first registration response message carries the first information; and 2) in a case that the first terminal sends an SL-MO-LR to the network side device, receive a first response message from the network side device, where the first response message is used to indicate the first information.

Optionally, the first capability includes a capability of serving as at least one of the following: a. a target UE; b. a reference UE; c. a client UE; d. an SL positioning server UE; e. an SL located UE; and f. an assistant UE.

Optionally, the performing module 1702 is specifically configured to:

(1) in a case that the first terminal does not support the ranging or SL positioning function, and the first information indicates that at least one of the second terminal, the serving network of the second terminal, and the serving network of the first terminal supports the ranging or SL positioning function, perform at least one of the following operations: initiating the SL-MO-LR to the serving network of the first terminal; and requesting the positioning assistance data or the positioning measurement information from the second terminal; and

(2) in a case that the first terminal does not support the ranging or SL positioning function, and the first information indicates that the second terminal, the serving network of the second terminal, and the serving network of the first terminal do not support the ranging or SL positioning function, perform the discovery and selection operations on the SL positioning server UE.

Optionally, the performing module 1702 is further specifically configured to: 1) in a case that the first terminal does not support the ranging or SL positioning function, and the first information indicates that the second terminal supports the ranging or SL positioning function, request the positioning assistance data or the positioning measurement information from the second terminal; 2) in a case that the first terminal does not support the ranging or SL positioning function, and the first information indicates that the serving network of the second terminal supports the ranging or SL positioning function, request the positioning assistance data or the positioning measurement information from the second terminal; and 3) in a case that the first terminal does not support the ranging or SL positioning function, and the first information indicates that the second terminal and the serving network of the second terminal do not support the ranging or SL positioning function and the serving network of the first terminal supports the ranging or SL positioning function, initiate the SL-MO-LR to the serving network of the first terminal.

Optionally, the network side device includes at least one of the following: a) an AMF; and b) an LMF.

FIG. 18 is a second schematic diagram of a structure of a ranging or SL positioning apparatus according to an embodiment of this application. As shown in FIG. 18, the ranging or SL positioning apparatus 1800 includes: a communication module 1801, configured to: send first information to a first terminal, where the first information is used to perform a ranging-related or SL positioning-related operation; or receive first information from a first terminal; and perform a ranging-related or SL positioning-related operation based on the first information, where the first information is used to indicate at least one of the following: 2) whether the second terminal supports the ranging or SL positioning function; and 3) whether a serving network of the second terminal supports the ranging or SL positioning function, where the second terminal is a reference terminal discovered by the first terminal to perform the ranging-related or SL positioning-related operation.

1) whether a serving network of the first terminal supports a ranging or SL positioning function;

In the ranging or SL positioning apparatus provided in this embodiment of this application, the communication module may send the first information to the first terminal, or receive the first information from the first terminal; perform the ranging-related or SL positioning-related operation based on the first information; learn of, based on the first information, whether the serving network of the first terminal, the second terminal, and the serving network of the second terminal support the ranging or SL positioning function; and then perform the ranging-related or SL positioning-related operation with reference to the first information. Compared with a related technology in which a target UE or a reference UE directly discovers and selects an SL positioning server UE to assist the target UE in implementing the ranging or SL positioning function, in this application, the first information is referred to, to avoid a case that a new SL positioning server UE is introduced to perform the ranging-related or SL positioning-related operation in a case that the serving network of the first terminal, the second terminal, or the serving network of the second terminal supports the ranging or SL positioning function or the like. This effectively reduces potential privacy and security risks.

Optionally, the communication module 1801 is specifically configured to perform at least one of the following: 1) sending a discovery message to the first terminal, where the discovery message carries the first information, and the discovery message includes at least one of the following: an announcement message in a model A discovery scenario, and a reply message in a model B discovery scenario; and 2) sending a capability interaction message to the first terminal, where the capability interaction message carries the first information, and the capability interaction message includes at least one of a capability response message and a capability providing message.

Optionally, the communication module 1801 is further specifically configured to: receive a positioning assistance data request or a positioning measurement information request from the first terminal, where the positioning assistance data request or the positioning measurement information request carries the first information.

Optionally, the communication module 1801 is further specifically configured to: 1) in a case that the first information only indicates that the serving network of the first terminal does not support the ranging or SL positioning function, initiate an SL-MO-LR to the serving network of the second terminal; and 2) in a case that the first information indicates that the serving network of the first terminal and the serving network of the second terminal do not support the ranging or SL positioning function, perform discovery and selection operations on an SL positioning server UE.

Optionally, the ranging or SL positioning apparatus 1800 further includes a first processing module, configured to: obtain second information; and generate the first information based on the second information, where the second information is used to indicate at least one of the following: a. whether the second terminal supports a function corresponding to the SL positioning server UE; b. whether the serving network of the second terminal supports the ranging or SL positioning function; c. whether the second terminal is within a service area; and d. whether the second terminal is within a restricted area.

Optionally, the first processing module is specifically configured to: 1) in a case that the second information indicates that the second terminal supports the function corresponding to the SL positioning server UE, generate the first information used to indicate that the second terminal supports the ranging or SL positioning function; 2) in a case that the second information indicates that the second terminal does not support the function corresponding to the SL positioning server UE, generate the first information used to indicate that the second terminal does not support the ranging or SL positioning function; 3) in a case that the second information indicates that the serving network of the second terminal supports the ranging or SL positioning function, generate the first information used to indicate that the serving network of the second terminal supports the ranging or SL positioning function; 4) in a case that the second information indicates that the serving network of the second terminal does not support the ranging or SL positioning function, generate the first information used to indicate that the serving network of the second terminal does not support the ranging or SL positioning function; 5) in a case that the second information indicates that the second terminal is not within the service area, generate the first information used to indicate that the serving network of the second terminal does not support the ranging or SL positioning function; and 6) in a case that the second information indicates that the second terminal is within the restricted area, generate the first information used to indicate that the serving network of the second terminal does not support the ranging or SL positioning function.

Optionally, the first processing module is further specifically configured to: 1) in a case that the second terminal sends a second registration request message to a network side device, receive a second registration response message from the network side device, where the network side device is related to the serving network of the second terminal, the second registration request message carries second capability information corresponding to the second terminal, the second capability information is used to indicate a second capability supported by the second terminal in a ranging or SL positioning process, and the second registration response message carries the second information; and

2) in a case that the second terminal sends an SL-MO-LR to the network side device, receive a second response message from the network side device, where the network side device is related to the serving network of the second terminal, and the second response message is used to indicate the second information.

Optionally, the second capability includes a capability of serving as at least one of the following: a. a target UE; b. a reference UE; c. a client UE; d. an SL positioning server UE; e. an SL located UE; and f. an assistant UE.

Optionally, the network side device may include at least one of the following: a) an AMF; and b) an LMF.

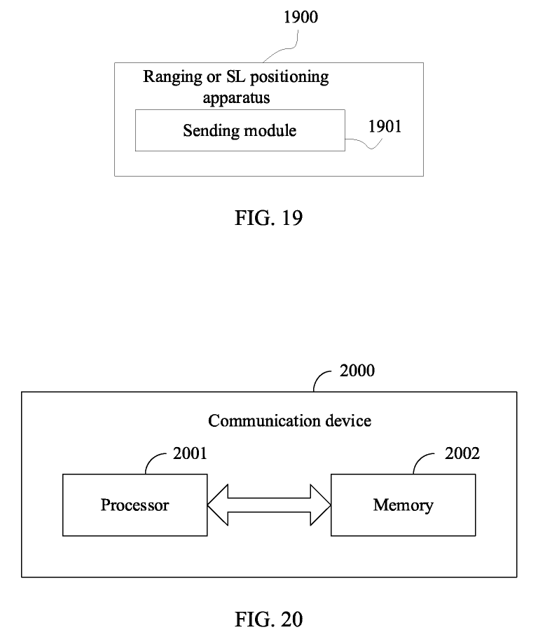

FIG. 19 is a third schematic diagram of a structure of a ranging or SL positioning apparatus according to an embodiment of this application. As shown in FIG. 19, the ranging or SL positioning apparatus 1900 includes:

a sending module 1901, configured to:

send first information to a first terminal, where the first information is used to perform a ranging-related or SL positioning-related operation; or

send second information to a second terminal, where the second information is used to generate first information, the first information is used to perform a ranging-related or SL positioning-related operation, and the second information is used to indicate at least one of the following: whether the second terminal supports a function corresponding to a sidelink positioning server user equipment SL positioning server UE; whether a serving network of the second terminal supports a ranging or SL positioning function; whether the second terminal is within a service area; and whether the second terminal is within a restricted area; and

the first information is used to indicate at least one of the following:

1) whether a serving network of the first terminal supports the ranging or SL positioning function;

2) whether the second terminal supports the ranging or SL positioning function; and

3) whether the serving network of the second terminal supports the ranging or SL positioning function, where the second terminal is a reference terminal discovered by the first terminal to perform the ranging-related or SL positioning-related operation.

In the ranging or SL positioning apparatus provided in this embodiment of this application, the sending module may send the first information to the first terminal, or send the second information used to generate the first information to the second terminal. Further, the first terminal or the second terminal may learn of, based on the first information, whether the serving network of the first terminal, the second terminal, and the serving network of the second terminal support the ranging or SL positioning function, and then perform the ranging-related or SL positioning-related operation with reference to the first information. Compared with a related technology in which a target UE or a reference UE directly discovers and selects an SL positioning server UE to assist the target UE in implementing the ranging or SL positioning function, in this application, the first information is referred to, to avoid a case that a new SL positioning server UE is introduced to perform the ranging-related or SL positioning-related operation in a case that the serving network of the first terminal, the second terminal, or the serving network of the second terminal supports the ranging or SL positioning function or the like. This effectively reduces potential privacy and security risks.

Optionally, the ranging or SL positioning apparatus 1900 further includes a second processing module, configured to: receive a first registration request message from the first terminal, where the first registration request message carries first capability information corresponding to the first terminal, the first capability information is used to indicate a first capability supported by the first terminal in a ranging or SL positioning process; and generate the first information based on the first capability information and/or first subscription information, where the first subscription information is used to indicate whether the ranging or SL positioning function of the first terminal is authorized; and the sending module 1901 is specifically configured to: send a first registration response message to the first terminal, where the first registration response message carries the first information.

Optionally, the first capability includes a capability of serving as at least one of the following: a. a target UE; b. a reference UE; c. a client UE; d. an SL positioning server UE; e. an SL located UE; and f. an assistant UE.

Optionally, the second processing module is further configured to: receive a sidelink mobile originated location request SL-MO-LR from the first terminal; and the sending first information to a first terminal includes: send a first response message to the first terminal, where the first response message is used to indicate the first information.

Optionally, the second processing module is further configured to: receive a second registration request message from the second terminal, where the second registration request message carries second capability information corresponding to the second terminal, and the second capability information is used to indicate a second capability supported by the second terminal in a ranging or SL positioning process; and generate the second information based on the second capability information and/or second subscription information, where the second subscription information is used to indicate whether the ranging or SL positioning function of the second terminal is authorized; and the sending module 1901 is further specifically configured to: send a second registration response message to the second terminal, where the second registration response message carries the second information.

Optionally, the second capability includes a capability of serving as at least one of the following: a. a target UE; b. a reference UE; c. a client UE; d. an SL positioning server UE; e. an SL located UE; and f. an assistant UE.

Optionally, the second processing module is further configured to: receive an SL-MO-LR from the second terminal; and the sending module 1901 is further specifically configured to: send a second response message to the second terminal, where the second response message is used to indicate the second information.

Optionally, the network side device may include at least one of the following: a) an AMF; and b) an LMF.

The ranging or SL positioning apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in this embodiment of this application.

The ranging or SL positioning apparatus provided in this embodiment of this application can implement the processes implemented in the method embodiments in FIGS. 2 to 16, with same technical effect achieved. To avoid repetition, details are not described herein again.

FIG. 20 is a schematic diagram of a structure of a communication device according to an embodiment of this application. As shown in FIG. 20, an embodiment of this application further provides a communication device 2000 including a processor 2001 and a memory 2002. The memory 2002 stores a program or an instruction that is executable on the processor 2001. For example, when the communication device 2000 is a first terminal, the program or the instruction is executed by the processor 2001 to implement the steps of the foregoing embodiments of the ranging or SL positioning method on the first terminal side, and a same technical effect can be achieved. When the communication device 2000 is a second terminal, the program or the instruction is executed by the processor 2001 to implement the steps of the foregoing embodiments of the ranging or SL positioning method on the second terminal side, and a same technical effect can be achieved. When the communication device 2000 is a network side device, the program or the instruction is executed by the processor 2001 to implement the steps of the foregoing embodiments of the ranging or SL positioning method on the network side, and a same technical effect can be achieved.

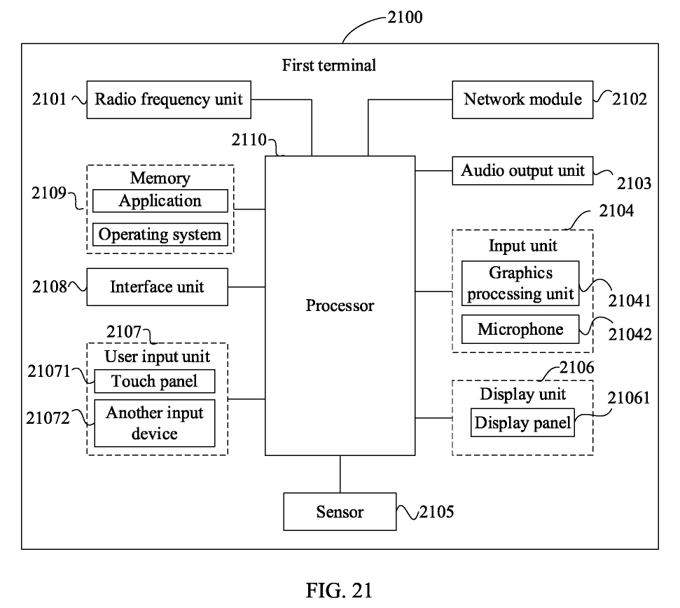

An embodiment of this application further provides a first terminal, including a processor and a communication interface. The communication interface is coupled to the processor, and the processor is configured to run a program or an instruction to implement the steps in the method embodiment shown in FIG. 2. The embodiment of the first terminal corresponds to the method embodiment on the first terminal side, each implementation process and implementation of the method embodiment can be applied to the embodiment of the first terminal, and a same technical effect can be achieved. Specifically, FIG. 21 is a schematic diagram of a hardware structure of a first terminal according to an embodiment of this application.

The first terminal 2100 includes but is not limited to components such as a radio frequency unit 2101, a network module 2102, an audio output unit 2103, an input unit 2104, a sensor 2105, a display unit 2106, a user input unit 2107, an interface unit 2108, a memory 2109, and a processor 2110.

A person skilled in the art can understand that the first terminal 2100 may further include a power supply (such as a battery) that supplies power to each component. The power supply may be logically connected to the processor 2110 by using a power supply management system, to implement functions such as charging and discharging management, and power consumption management by using the power supply management system. The structure of the first terminal shown in FIG. 21 constitutes no limitation on the first terminal, and the first terminal may include more or fewer components than those shown in the figure, or combine some components, or have different component arrangements. Details are not described herein.

It should be understood that, in this embodiment of this application, the input unit 2104 may include a graphics processing unit (Graphics Processing Unit, GPU) 21041 and a microphone 21042, and the graphics processing unit 21041 processes image data of a still picture or a video obtained by an image capture apparatus (a camera) in a video capture mode or an image capture mode. The display unit 2106 may include a display panel 21061, and the display panel 21061 may be configured in a form of a liquid crystal display, an organic light-emitting diode, or the like. The user input unit 2107 includes at least one of a touch panel 21071 and another input device 21072. The touch panel 21071 is also referred to as a touchscreen. The touch panel 21071 may include two parts: a touch detection apparatus and a touch controller. The another input device 21072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 2101 may transmit the downlink data to the processor 2110 for processing. In addition, the radio frequency unit 2101 may send uplink data to the network side device. Generally, the radio frequency unit 2101 includes but is not limited to an antenna, an amplifier, a transceiver, a coupler, a low noise amplifier, a duplexer, and the like.

The memory 2109 may be configured to store a software program or an instruction and various data. The memory 2109 may mainly include a first storage area for storing a program or an instruction and a second storage area for storing data. The first storage area may store an operating system, and an application or an instruction required by at least one function (for example, a sound playing function or an image playing function). In addition, the memory 2109 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 2109 in this embodiment of this application includes but is not limited to these memories and any memory of another proper type.

The processor 2110 may include one or more processing units. Optionally, an application processor and a modem processor are integrated into the processor 2110. The application processor mainly processes an operating system, a user interface, an application, and the like. The modem processor mainly processes a wireless communication signal, for example, a baseband processor. It may be understood that, alternatively, the modem processor may not be integrated into the processor 2110.

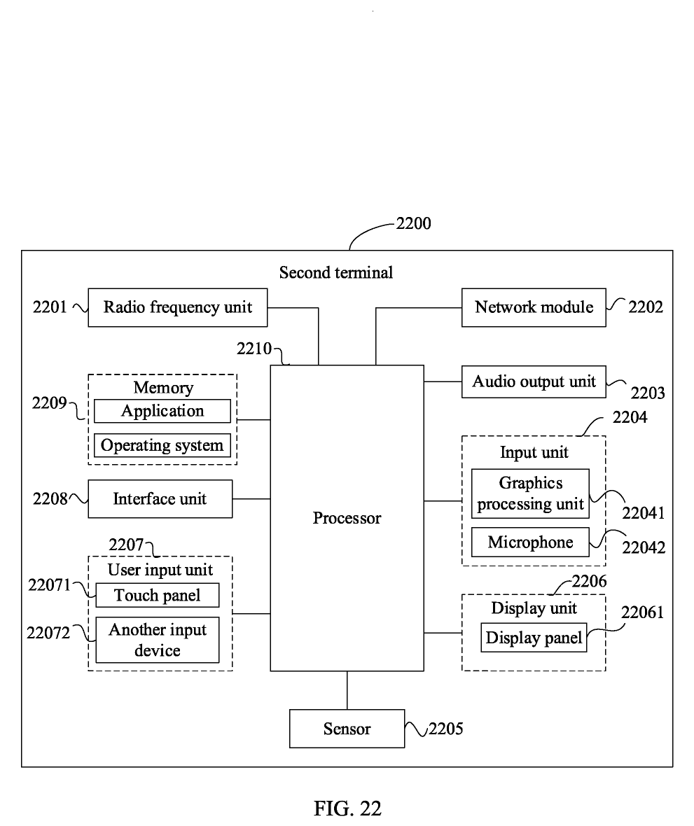

An embodiment of this application further provides a second terminal, including a processor and a communication interface. The communication interface is coupled to the processor, and the processor is configured to run a program or an instruction to implement the steps in the method embodiment shown in FIG. 3. The embodiment of the second terminal corresponds to the method embodiment on the second terminal side, each implementation process and implementation of the method embodiment can be applied to the embodiment of the second terminal, and a same technical effect can be achieved. Specifically, FIG. 22 is a schematic diagram of a hardware structure of a second terminal according to an embodiment of this application.

The second terminal 2200 includes but is not limited to at least some components in a radio frequency unit 2201, a network module 2202, an audio output unit 2203, an input unit 2204, a sensor 2205, a display unit 2206, a user input unit 2207, an interface unit 2208, a memory 2209, and a processor 2210.

A person skilled in the art can understand that the second terminal 2200 may further include a power supply (such as a battery) that supplies power to each component. The power supply may be logically connected to the processor 2210 by using a power supply management system, to implement functions such as charging and discharging management, and power consumption management by using the power supply management system. The structure of the second terminal shown in FIG. 21 constitutes no limitation on the second terminal, and the second terminal may include more or fewer components than those shown in the figure, or combine some components, or have different component arrangements. Details are not described herein.

It should be understood that, in this embodiment of this application, the input unit 2204 may include a graphics processing unit (Graphics Processing Unit, GPU) 22041 and a microphone 22042, and the graphics processing unit 22041 processes image data of a still picture or a video obtained by an image capture apparatus (a camera) in a video capture mode or an image capture mode. The display unit 2206 may include a display panel 22061, and the display panel 22061 may be configured in a form of a liquid crystal display, an organic light-emitting diode, or the like. The user input unit 2207 includes at least one of a touch panel 22071 and another input device 22072. The touch panel 22071 is also referred to as a touchscreen. The touch panel 22071 may include two parts: a touch detection apparatus and a touch controller. The another input device 22072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 2201 may transmit the downlink data to the processor 2210 for processing. In addition, the radio frequency unit 2201 may send uplink data to the network side device. Generally, the radio frequency unit 2201 includes but is not limited to an antenna, an amplifier, a transceiver, a coupler, a low noise amplifier, a duplexer, and the like.

The memory 2209 may be configured to store a software program or an instruction and various data. The memory 2209 may mainly include a first storage area for storing a program or an instruction and a second storage area for storing data. The first storage area may store an operating system, and an application or an instruction required by at least one function (for example, a sound playing function or an image playing function). In addition, the memory 2209 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 2209 in this embodiment of this application includes but is not limited to these memories and any memory of another proper type.

The processor 2210 may include one or more processing units. Optionally, an application processor and a modem processor are integrated into the processor 2210. The application processor mainly processes an operating system, a user interface, an application, and the like. The modem processor mainly processes a wireless communication signal, for example, a baseband processor. It may be understood that, alternatively, the modem processor may not be integrated into the processor 2210.

It may be understood that for the implementation processes of the implementations mentioned in this embodiment, refer to the related descriptions of the ranging or SL positioning method in the method embodiment. A same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps in the method embodiment shown in FIG. 4. This network side device embodiment is corresponding to the foregoing method embodiment of the network side device. Each implementation process and implementation of the foregoing method embodiment may be applicable to this network side device embodiment, and a same technical effect can be achieved.

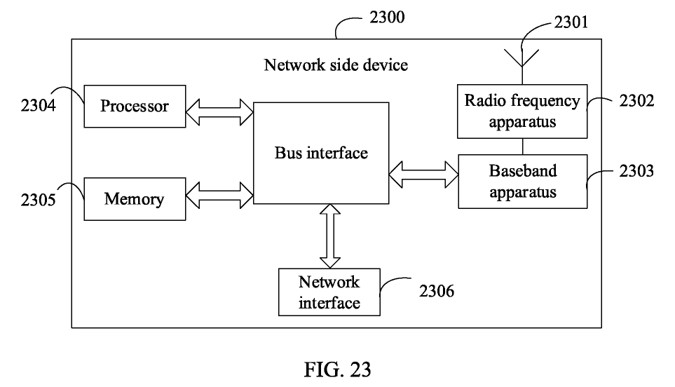

Specifically, an embodiment of this application further provides a network side device. FIG. 23 is a schematic diagram of a structure of a network side device according to an embodiment of this application. As shown in FIG. 23, the network side device 2300 includes an antenna 2301, a radio frequency apparatus 2302, a baseband apparatus 2303, a processor 2304, and a memory 2305. The antenna 2301 is connected to the radio frequency apparatus 2302. In an uplink direction, the radio frequency apparatus 2302 receives information through the antenna 2301, and sends the received information to the baseband apparatus 2303 for processing. In a downlink direction, the baseband apparatus 2303 processes information that needs to be sent, and sends processed information to the radio frequency apparatus 2302. The radio frequency apparatus 2302 processes the received information, and sends processed information through the antenna 2301.

In the foregoing embodiment, the method performed by the network side device may be implemented in the baseband apparatus 2303. The baseband apparatus 2303 includes a baseband processor.

For example, the baseband apparatus 2303 may include at least one baseband board. A plurality of chips are disposed on the baseband board. As shown in FIG. 23, one chip is, for example, a baseband processor, and is connected to the memory 2305 by using a bus interface, to invoke a program in the memory 2305 to perform the operations of the network device shown in the foregoing method embodiment.

The network side device may further include a network interface 2306, and the interface is, for example, a common public radio interface (Common Public Radio Interface, CPRI).

Specifically, the network side device 2300 in this embodiment of this application further includes an instruction or a program that is stored in the memory 2305 and that is executable on the processor 2304. The processor 2304 invokes the instruction or the program in the memory 2305 to execute the method executed by the modules shown in FIG. 18, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing embodiment of the ranging or SL positioning method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface, the communication interface is coupled to the processor, and the processor is configured to run a program or an instruction to implement the processes of the foregoing embodiment of the ranging or SL positioning method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing embodiment of the ranging or SL positioning method, and a same technical effect can be achieved. To avoid repetition, details are not described herein again.

An embodiment of this application further provides a ranging or SL positioning system, including a first terminal, a second terminal, and a network side device. The first terminal may be configured to perform the steps of the ranging or SL positioning method on the first terminal side, the second terminal may be configured to perform the steps of the ranging or SL positioning method on the second terminal side, and the network side device may be configured to perform the steps of the ranging or SL positioning method on the network side.

It should be noted that, in this specification, the term "include", "comprise", or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by "includes a..." does not preclude the existence of other identical elements in the process, method, article, or apparatus that includes the element. In addition, it should be noted that the scope of the method and apparatuses in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or by hardware only. The computer software product is stored in a storage medium (such as a ROM, a RAM, a magnetic disk, or an optical disc), and includes several instructions for instructing a terminal or a network side device to perform the methods in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make implementations in many forms without departing from the purpose of this application and the protection scope of the claims, the implementations fall within the protection of this application.

What claimed is:

1. A ranging or sidelink SL positioning method, wherein the method comprises:
obtaining, by a first terminal, first information; and
performing, by the first terminal, a ranging-related or SL positioning-related operation based on the first information, wherein
the first information is used to indicate at least one of the following:
whether a serving network of the first terminal supports a ranging or SL positioning function;
whether a second terminal supports the ranging or SL positioning function; or
whether a serving network of the second terminal supports the ranging or SL positioning function, wherein
the second terminal is a reference terminal discovered by the first terminal to perform the ranging-related or SL positioning-related operation.

2. The ranging or sidelink SL positioning method according to claim 1, wherein the ranging-related or SL positioning-related operation comprises at least one of the following:
initiating a sidelink mobile originated location request SL-MO-LR to the serving network of the first terminal;
discovery and selection operations on a sidelink positioning server user equipment SL positioning server UE; or
requesting positioning assistance data or positioning measurement information from the second terminal.

3. The ranging or sidelink SL positioning method according to claim 1, wherein the obtaining, by a first terminal, first information comprises at least one of the following:
receiving, by the first terminal, the first information from the second terminal; or
receiving, by the first terminal, the first information from a network side device, wherein the network side device is related to the serving network of the first terminal.

4. The ranging or sidelink SL positioning method according to claim 3, wherein the receiving, by the first terminal, the first information from the second terminal comprises at least one of the following:
receiving, by the first terminal, a discovery message from the second terminal, wherein the discovery message carries the first information, and the discovery message comprises at least one of the following: an announcement message in a model (Model) A discovery (discovery) scenario, or a reply message in a model B discovery scenario; or
receiving, by the first terminal, a capability interaction message from the second terminal, wherein the capability interaction message carries the first information, and the capability interaction message comprises at least one of a capability response message or a capability providing message.

5. The ranging or sidelink SL positioning method according to claim 3, wherein the receiving, by the first terminal, the first information from a network side device comprises:
in a case that the first terminal sends a first registration request message to the network side device, receiving, by the first terminal, a first registration response message from the network side device, wherein the first registration request message carries first capability information corresponding to the first terminal, the first capability information is used to indicate a first capability supported by the first terminal in a ranging or SL positioning process, and the first registration response message carries the first information; and
in a case that the first terminal sends an SL-MO-LR to the network side device, receiving, by the first terminal, a first response message from the network side device, wherein the first response message is used to indicate the first information.

6. The ranging or sidelink SL positioning method according to claim 5, wherein the first capability comprises a capability of serving as at least one of the following:
a target user equipment UE;
a reference UE;
a client (client) UE;
an SL positioning server UE;
an SL located (located) UE; or
an assistant (Assistant) UE.

7. The ranging or sidelink SL positioning method according to claim 1, wherein the performing, by the first terminal, a ranging-related or SL positioning-related operation based on the first information comprises:
in a case that the first terminal does not support the ranging or SL positioning function, and the first information indicates that at least one of the second terminal, the serving network of the second terminal, or the serving network of the first terminal supports the ranging or SL positioning function, performing, by the first terminal, at least one of the following operations: initiating the SL-MO-LR to the serving network of the first terminal; or requesting the positioning assistance data or the positioning measurement information from the second terminal; and
in a case that the first terminal does not support the ranging or SL positioning function, and the first information indicates that the second terminal, the serving network of the second terminal, and the serving network of the first terminal do not support the ranging or SL positioning function, performing, by the first terminal, the discovery and selection operations on the SL positioning server UE.

8. The ranging or sidelink SL positioning method according to claim 7, wherein in the case that the first terminal does not support the ranging or SL positioning function, and the first information indicates that at least one of the second terminal, the serving network of the second terminal, or the serving network of the first terminal supports the ranging or SL positioning function, the performing a ranging-related or SL positioning-related operation further comprises at least one of the following:
in a case that the first terminal does not support the ranging or SL positioning function, and the first information indicates that the second terminal supports the ranging or SL positioning function, requesting, by the first terminal, the positioning assistance data or the positioning measurement information from the second terminal;
in a case that the first terminal does not support the ranging or SL positioning function, and the first information indicates that the serving network of the second terminal supports the ranging or SL positioning function, requesting, by the first terminal, the positioning assistance data or the positioning measurement information from the second terminal; or
in a case that the first terminal does not support the ranging or SL positioning function, and the first information indicates that the second terminal and the serving network of the second terminal do not support the ranging or SL positioning function and the serving network of the first terminal supports the ranging or SL positioning function, initiating, by the first terminal, the SL-MO-LR to the serving network of the first terminal.

9. The ranging or sidelink SL positioning method according to claim 3, wherein the network side device comprises at least one of the following:
an access and mobility management function AMF; or
a location management function LMF.

10. A ranging or sidelink SL positioning method, wherein the method comprises:
sending, by a second terminal, first information to a first terminal, wherein the first information is used to perform a ranging-related or SL positioning-related operation; or
receiving, by a second terminal, first information from a first terminal; and performing, by the second terminal, a ranging-related or SL positioning-related operation based on the first information, wherein
the first information is used to indicate at least one of the following:
whether a serving network of the first terminal supports a ranging or SL positioning function;
whether the second terminal supports the ranging or SL positioning function; or
whether a serving network of the second terminal supports the ranging or SL positioning function, wherein
the second terminal is a reference terminal discovered by the first terminal to perform the ranging-related or SL positioning-related operation.

11. The ranging or sidelink SL positioning method according to claim 10, wherein the sending, by a second terminal, first information to a first terminal comprises at least one of the following:
sending, by the second terminal, a discovery message to the first terminal, wherein the discovery message carries the first information, and the discovery message comprises at least one of the following: an announcement message in a model (Model) A discovery (discovery) scenario, or a reply message in a model B discovery scenario; or
sending, by the second terminal, a capability interaction message to the first terminal, wherein the capability interaction message carries the first information, and the capability interaction message comprises at least one of a capability response message or a capability providing message.

12. The ranging or sidelink SL positioning method according to claim 10, wherein the receiving, by a second terminal, first information from a first terminal comprises:
receiving, by the second terminal, a positioning assistance data request or a positioning measurement information request from the first terminal, wherein the positioning assistance data request or the positioning measurement information request carries the first information.

13. The ranging or sidelink SL positioning method according to claim 10, wherein the performing, by the second terminal, a ranging-related or SL positioning-related operation based on the first information comprises:
in a case that the first information only indicates that the serving network of the first terminal does not support the ranging or SL positioning function, initiating, by the second terminal, an SL-MO-LR to the serving network of the second terminal; and
in a case that the first information indicates that the serving network of the first terminal and the serving network of the second terminal do not support the ranging or SL positioning function, performing, by the second terminal, discovery and selection operations on a sidelink positioning server user equipment SL positioning server UE.

14. The ranging or sidelink SL positioning method according to claim 10, wherein the method further comprises:
obtaining, by the second terminal, second information; and
generating, by the second terminal, the first information based on the second information, wherein
the second information is used to indicate at least one of the following:
whether the second terminal supports a function corresponding to the SL positioning server UE;
whether the serving network of the second terminal supports the ranging or SL positioning function;
whether the second terminal is within a service area; or
whether the second terminal is within a restricted area.

15. The ranging or sidelink SL positioning method according to claim 14, wherein the generating, by the second terminal, the first information based on the second information comprises:
in a case that the second information indicates that the second terminal supports the function corresponding to the SL positioning server UE, generating, by the second terminal, the first information used to indicate that the second terminal supports the ranging or SL positioning function;
in a case that the second information indicates that the second terminal does not support the function corresponding to the SL positioning server UE, generating, by the second terminal, the first information used to indicate that the second terminal does not support the ranging or SL positioning function;
in a case that the second information indicates that the serving network of the second terminal supports the ranging or SL positioning function, generating, by the second terminal, the first information used to indicate that the serving network of the second terminal supports the ranging or SL positioning function;
in a case that the second information indicates that the serving network of the second terminal does not support the ranging or SL positioning function, generating, by the second terminal, the first information used to indicate that the serving network of the second terminal does not support the ranging or SL positioning function;
in a case that the second information indicates that the second terminal is not within the service area, generating, by the second terminal, the first information used to indicate that the serving network of the second terminal does not support the ranging or SL positioning function; and
in a case that the second information indicates that the second terminal is within the restricted area, generating, by the second terminal, the first information used to indicate that the serving network of the second terminal does not support the ranging or SL positioning function.

16. A ranging or sidelink SL positioning method, wherein the method comprises:
sending, by a network side device, first information to a first terminal, wherein the first information is used to perform a ranging-related or SL positioning-related operation; or
sending, by a network side device, second information to a second terminal, wherein the second information is used to generate first information, the first information is used to perform a ranging-related or SL positioning-related operation, and the second information is used to indicate at least one of the following: whether the second terminal supports a function corresponding to a sidelink positioning server user equipment SL positioning server UE; whether a serving network of the second terminal supports a ranging or SL positioning function; or whether the second terminal is within a service area; and whether the second terminal is within a restricted area; and
the first information is used to indicate at least one of the following:
whether a serving network of the first terminal supports the ranging or SL positioning function;
whether the second terminal supports the ranging or SL positioning function; or
whether the serving network of the second terminal supports the ranging or SL positioning function, wherein
the second terminal is a reference terminal discovered by the first terminal to perform the ranging-related or SL positioning-related operation.

17. The ranging or sidelink SL positioning method according to claim 16, wherein the method further comprises:
receiving, by the network side device, a first registration request message from the first terminal, wherein the first registration request message carries first capability information corresponding to the first terminal, the first capability information is used to indicate a first capability supported by the first terminal in a ranging or SL positioning process; and
generating, by the network side device, the first information based on the first capability information and/or first subscription information, wherein the first subscription information is used to indicate whether the ranging or SL positioning function of the first terminal is authorized; and
the sending, by a network side device, first information to a first terminal comprises:
sending, by the network side device, a first registration response message to the first terminal, wherein the first registration response message carries the first information.

18. A first terminal, wherein the first terminal comprises a processor and a memory, wherein the memory stores a program or an instruction that is executable on the processor, the program or the instruction is executed by the processor to implement the steps of the ranging or sidelink SL positioning method according to claim 1.

19. A second terminal, wherein the second terminal comprises a processor and a memory, wherein the memory stores a program or an instruction that is executable on the processor, the program or the instruction is executed by the processor to implement the steps of the ranging or sidelink SL positioning method according to claim 10.

20. A network side device, wherein the network side device comprises a processor and a memory, wherein the memory stores a program or an instruction that is executable on the processor, and the program or the instruction is executed by the processor to implement the steps of the ranging or sidelink SL positioning method according to claim 16.
